(19) United States
(12) Patent Application Publication
(10) Pub. No.: US 2015/0350974 A1
(43) Pub. Date: Dec. 3, 2015

(54) ENHANCEMENT FOR BSS TRANSITION, LOAD BALANCING AND AP SELECTION

(71) Applicant: QUALCOMM Incorporated, San Diego, CA (US)

(72) Inventors: Abhishek Pramod PATIL, San Diego, CA (US); George CHERIAN, San Diego, CA (US); Santosh Paul ABRAHAM, San Diego, CA (US)

(21) Appl. No.: 14/726,181

(22) Filed: May 29, 2015

Related U.S. Application Data
(60) Provisional application No. 62/078,827, filed on Nov. 12, 2014.
(60) Provisional application No. 62/005,987, filed on May 30, 2014.

(51) Int. Cl. H04W 36/00; H04W 48/20; H04W 28/08

(52) U.S. Cl. CPC H04W 36/0083; H04W 28/08; H04W 48/20; H04W 36/24

(57) ABSTRACT

A method, an apparatus, and a computer program product for wireless communication are provided. In one aspect, the apparatus may be a station. The apparatus receives a request including at least one information identifier from a first access point (AP) associated with the station. The apparatus collects information indicated by the at least one information identifier from each of a plurality of APs to generate a report including AP information of the plurality of APs. The apparatus sends the report including the AP information of the plurality of APs to the first AP, where the first AP generates a neighbor report including the AP information of the plurality of APs. Other embodiments are also included.

### CROSS-REFERENCE TO RELATED APPLICATION(S)

This application claims the benefit of U.S. Provisional Application Ser. No. 62/005,987, entitled “ENHANCEMENT FOR BSS TRANSITION, LOAD BALANCING AND AP SELECTION” and filed on May 30, 2014, and U.S. Provisional Application Ser. No. 62/078,827, entitled “ENHANCEMENT FOR BSS TRANSITION, LOAD BALANCING AND AP SELECTION” and filed on Nov. 12, 2014, which are expressly incorporated by reference herein in their entirety.

### BACKGROUND

1. Field

The present disclosure relates generally to communication systems, and more particularly, to basic service set (BSS) transition, load balancing, and access point (AP) selection in a wireless communication system including one or more stations and multiple APs.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved narrowband channel selection for devices in a wireless network.

One aspect of this disclosure provides a station for wireless communication. The station is configured to receive access point (AP) association information for each of one or more APs, and to determine to associate with one of the one or more APs based on the received AP association information.

Another aspect of this disclosure provides a method of wireless communication at a station including receiving AP association information for each of one or more APs, and determining to associate with one of the one or more APs based on the received AP association information.

One aspect of this disclosure provides a station for wireless communication including means for receiving AP association information for each of one or more APs, and means for determining to associate with one of the one or more APs based on the received AP association information.

Another aspect of this disclosure provides a computer program product for wireless communications at a station, the computer program product including a computer-readable medium having instructions executable to receive access point (AP) association information for each of one or more APs, and to determine to associate with one of the one or more APs based on the received AP association information.

One aspect of this disclosure provides a station for wireless communication. The station is configured to receive a request including at least one information identifier from a first access point (AP) associated with the station, collect information indicated by the at least one information identifier from each of a plurality of APs to generate a report including AP information of the plurality of APs, and send the report including the AP information of the plurality of APs to the first AP, where the first AP generates a neighbor report including the AP information of the plurality of APs.

Another aspect of this disclosure provides a method of wireless communication at a station including receiving a request including at least one information identifier from a first AP associated with the station, collecting information indicated by the at least one information identifier from each of a plurality of APs to generate a report including AP information of the plurality of APs, and sending the report including the AP information of the plurality of APs to the first AP, where the first AP generates a neighbor report including the AP information of the plurality of APs.

One aspect of this disclosure provides a station for wireless communication including means for receiving a request including at least one information identifier from a first AP associated with the station, means for collecting information indicated by the at least one information identifier from each of a plurality of APs to generate a report including AP information of the plurality of APs, and means for sending the report including the AP information of the plurality of APs to the first AP, where the first AP generates a neighbor report including the AP information of the plurality of APs.

Another aspect of this disclosure provides a computer program product for wireless communications at a station, the computer program product including a computer-readable medium having instructions executable to receive a request including at least one information identifier from a first AP associated with the station, collect information indicated by the at least one information identifier from each of a plurality of APs to generate a report including AP information of the plurality of APs, and send the report including the AP information of the plurality of APs to the first AP, where the first AP generates a neighbor report including the AP information of the plurality of APs.

One aspect of this disclosure provides a station for wireless communication. The station is configured to receive a neighbor report from one of a plurality of APs, where the neighbor report includes at least one of channel information on channels used by the plurality of APs, target beacon transmission time (TBTT) information for the channels used by the plurality of APs, basic service set (BSS) identifiers of the plurality of APs, a service set identifier (SSID) or a representation of the SSID of the one of the plurality of APs, load information of the plurality of APs or fast initial link setup (FILS) indication information of the plurality of APs, and to select one of the plurality of APs to associate with the station based on at least one of the channel information, the TBTT information, the BSS identifiers, the SSID or the representation of the SSID, the load information of the plurality of APs or the FILS indication information included in the neighbor report.

Another aspect of this disclosure provides a method of wireless communication for a station including receiving a neighbor report from one of a plurality of APs, where the neighbor report includes at least one of channel information on channels used by the plurality of APs, target beacon transmission time (TBTT) information for the channels used by the plurality of APs, basic service set (BSS) identifiers of the plurality of APs, a service set identifier (SSID) or a representation of the SSID of the one of the plurality of APs, load information of the plurality of APs, or FILS indication information of the plurality of APs, and selecting one of the plurality of APs to associate with the station based on at least one of the channel information, the TBTT information, the BSS identifiers, the SSID or the representation of the SSID, the load information of the plurality of APs, or the FILS indication information included in the neighbor report.

One aspect of this disclosure provides a station for wireless communication including means for receiving a neighbor report from one of a plurality of APs, where the neighbor report includes at least one of channel information on channels used by the plurality of APs, TBTT information for the channels used by the plurality of APs, BSS identifiers of the plurality of APs, an SSID or a representation of the SSID of the one of the plurality of APs, load information of the plurality of APs, or FILS indication information of the plurality of APs, and means for selecting one of the plurality of APs to associate with the station based on at least one of the channel information, the TBTT information, the BSS identifiers, the SSID or the representation of the SSID, the load information of the plurality of APs, or the FILS indication information included in the neighbor report.

Another aspect of this disclosure provides a computer program product for wireless communications at a station, the computer program product including a computer-readable medium having instructions executable to receive a neighbor report from one of a plurality of APs, where the neighbor report includes at least one of channel information on channels used by the plurality of APs, TBTT information for the channels used by the plurality of APs, BSS identifiers of the plurality of APs, an SSID or a representation of the SSID of the one of the plurality of APs, load information of the plurality of APs, or FILS indication information of the plurality of APs, and select one of the plurality of APs to associate with the station based on at least one of the channel information, the TBTT information, the BSS identifiers, the SSID or the representation of the SSID, the load information of the plurality of APs, or the FILS indication information included in the neighbor report.

One aspect of this disclosure provides a station for wireless communication. The station is configured to send channel information indicating one or more channels supported by the station to a first AP, to receive guidance information from the first AP, where the guidance information is generated based in part on the channel information to guide the station for association with one of a plurality of APs including the first AP, and to determine to associate with one of the plurality of APs based on the guidance information received from the first AP.

Another aspect of this disclosure provides a method of wireless communication at a station including sending channel information indicating one or more channels supported by the station to a first AP, receiving guidance information from the first AP, where the guidance information is generated based in part on the channel information to guide the station for association with one of a plurality of APs including the first AP, and determining to associate with one of the plurality of APs based on the guidance information received from the first AP.

One aspect of this disclosure provides a station for wireless communication including means for sending channel information indicating one or more channels supported by the station to a first AP, means for receiving guidance information from the first AP, where the guidance information is generated based in part on the channel information to guide the station for association with one of a plurality of APs including the first AP, and means for determining to associate with one of the plurality of APs based on the guidance information received from the first AP.

Another aspect of this disclosure provides a computer program product for wireless communications at a station, the computer program product including a computer-readable medium having instructions executable to send channel information indicating one or more channels supported by the station to a first AP, to receive guidance information from the first AP, where the guidance information is generated based in part on the channel information to guide the station for association with one of a plurality of APs including the first AP, and to determine to associate with one of the plurality of APs based on the guidance information received from the first AP.

One aspect of this disclosure provides a AP for wireless communication. The AP is configured to send a request including at least one information identifier to a station associated with the AP, where the at least one information identifier indicates AP information to be collected from a plurality of APs, receive the AP information of the plurality of APs from the station, and generate a neighbor report including the AP information of the plurality of APs.

Another aspect of this disclosure provides a method of wireless communication for an AP including sending a request including at least one information identifier to a station associated with the AP, where the at least one information identifier indicates AP information to be collected from a plurality of APs, receiving the AP information of the plurality of APs from the station, and generating a neighbor report including the AP information of the plurality of APs.

One aspect of this disclosure provides an AP for wireless communication including means for sending a request including at least one information identifier to a station associated with the AP, where the at least one information identifier indicates AP information to be collected from a plurality of APs, means for receiving the AP information of the plurality of APs from the station, and means for generating a neighbor report including the AP information of the plurality of APs.

Another aspect of this disclosure provides a computer program product for wireless communications at an AP, the computer program product including a computer-readable medium having instructions executable to send a request including at least one information identifier to a station associated with the AP, where the at least one information identifier indicates AP information to be collected from a plurality of APs, receive the AP information of the plurality of APs from the station, and generate a neighbor report including the AP information of the plurality of APs.

### BRIEF DESCRIPTION OF THE DRAWINGS

FIG. 1 shows an example wireless communication system in which aspects of the present disclosure may be employed.

FIG. 2 shows a functional block diagram of an example wireless device that may be employed within the wireless communication system of FIG. 1.

FIG. 3 is an example diagram illustrating a wireless communication network including stations and access points.

FIGS. 4A-4C are example diagrams illustrating an example structure of a beacon request.

FIG. 5 is an example diagram illustrating an example structure of a neighbor report.

FIG. 6 is a flowchart of an example method of wireless communication, according to an aspect.

FIG. 7A is a flowchart of an example method of wireless communication expanding from the aspect illustrated in FIG. 6.

FIG. 7B is a flowchart of an example method of wireless communication expanding from the aspect illustrated in FIG. 6.

FIG. 8 is a flowchart of an example method of wireless communication expanding from the aspect illustrated in FIG. 6.

FIG. 9A is a flowchart of an example method of wireless communication expanding from the aspect illustrated in FIG. 6.

FIG. 9B is a flowchart of an example method of wireless communication expanding from the aspect illustrated in FIG. 6.

FIG. 10A is a flowchart of an example method of wireless communication expanding from the aspect illustrated in FIG. 6.

FIG. 10B is a flowchart of an example method of wireless communication expanding from the aspect illustrated in FIG. 6.

FIG. 11 is a flowchart of an example method of wireless communication, according to an aspect.

FIG. 12 is a flowchart of an example method of wireless communication, according to an aspect.

FIG. 13 is a flowchart of an example method of wireless communication according to another aspect.

FIG. 14 is a functional block diagram of an example wireless communication device.

FIG. 15 shows a functional block diagram of an example wireless device that may be employed within the wireless communication system of FIG. 1.

FIG. 16 is a flowchart of an example method of wireless communication according to another aspect.

FIG. 17 is a functional block diagram of an example wireless communication device.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, connection point, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatus may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, terminology that recites at least one of a combination of elements (e.g., “at least one of A, B, or C”) refers to one or more of the recited elements (e.g., A, or B, or C, or any combination thereof).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

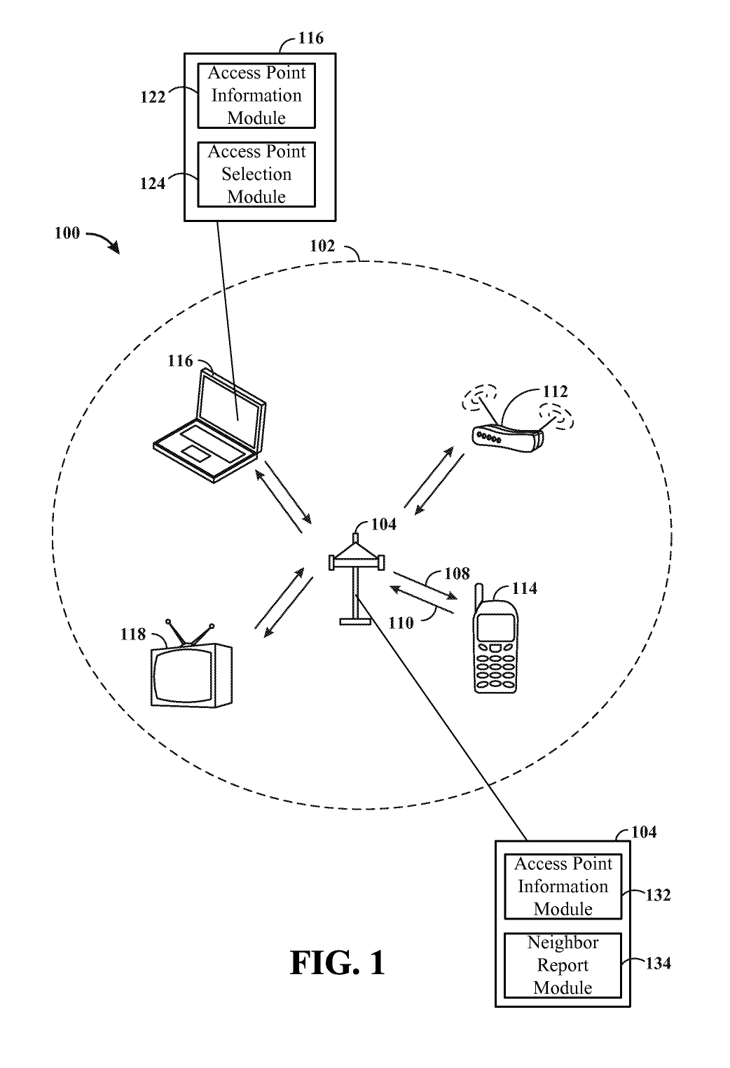

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. The AP 104 along with the STAs associated with the AP 104 and that use the AP 104 for communication may be referred to as a basic service set (BSS). It should be noted that the wireless communication system 100 may not have a central AP 104, but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information both common (e.g., shared) amongst several devices, and information specific to a given device.

In some aspects, a STA (e.g., STA 116) may be required to associate with the AP 104 in order to send communications to and/or receive communications from the AP 104. In one aspect, information for associating is included in a beacon broadcast by the AP 104. To receive such a beacon, the STA 116 may, for example, perform a broad coverage search over a coverage region. A search may also be performed by the STA 116 by sweeping a coverage region in a lighthouse fashion, for example. After receiving the information for associating, the STA 116 may transmit a reference signal, such as an association probe or request, to the AP 104. In some aspects, the AP 104 may use backhaul services, for example, to communicate with a larger network, such as the Internet or a public switched telephone network (PSTN).

In one aspect, a STA (e.g., STA 116) may include modules to perform various tasks. For example, the STA 116 may include an access point information module 122 to gather access point information from APs surrounding the STA 116, where the access point information may include at least one of load information, security information, IP subnet information, new association indication information. The STA 116 may include an access point selection module 124 to select an AP to associate among multiple APs, based on various factors such as load information, security information, IP subnet information, new association indication information of the surrounding APs. In one aspect, the AP 104 may include an access point information module 132 to receive access point information of surrounding APs from an associated STA (e.g., STA 116), and a neighbor report module 134 to generate a neighbor report including the access point information of surrounding APs.

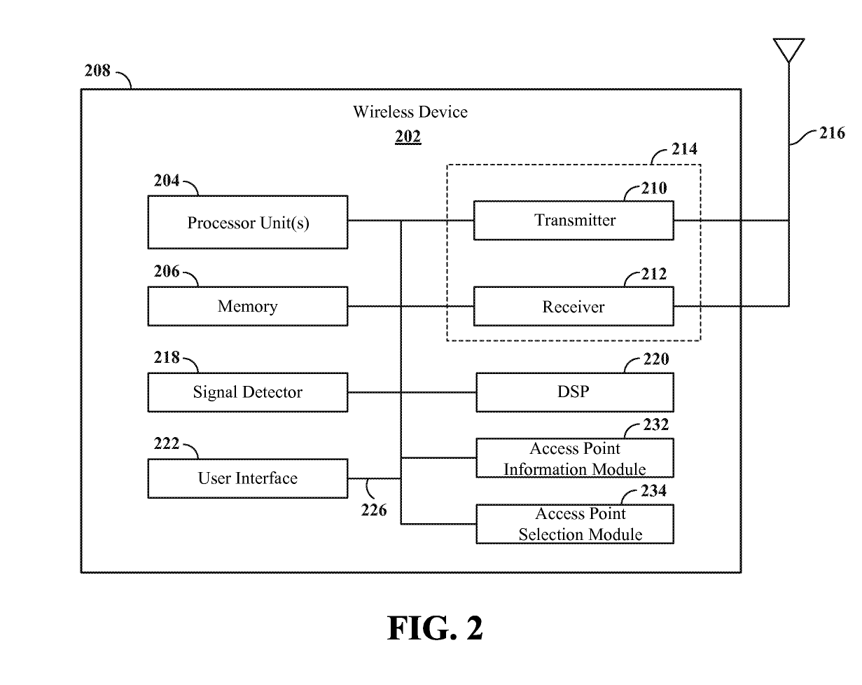

FIG. 2 shows an example functional block diagram of a wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 112, 114, 116, and 118.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The wireless device 202 may comprise an access point information module 232. If the wireless device 202 comprises one of the STAs 112, 114, 116, and 118, the access point information module 232 is configured to gather access point information from APs surrounding the STA 116, where the access point information may include at least one of load information, security information, IP subnet information, new association indication information. The access point information module 232 may be configured to receive AP association information for each of one or more APs. The access point selection module 234 may be configured to determine to associate with one of the one or more APs based on the received AP association information. access point information module 232 may be configured to receive a request including at least one information identifier from a first AP associated with the station, to collect information indicated by the at least one information identifier from each of a plurality of APs to generate a report including AP information of the plurality of APs, and to send the report including the AP information of the plurality of APs to the first AP.

The various components of the wireless device 202 may be coupled together by a bus system 226. The bus system 226 may include a data bus, for example, as well as a power bus, a control signal bus, and a status signal bus in addition to the data bus. Components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

Several limitations exist in current standards and Wi-Fi systems. Thus, an approach to effectively utilize and/or to combine features from IEEE 802.11v, 802.11k, and 802.11ai standards is desired. Further, approaches to aid a new station (STA) during selection of an AP, to perform load balancing to uniformly spread the load amongst all surrounding APs, and/or to maintain throughput and superior user experience for all STAs are desired.

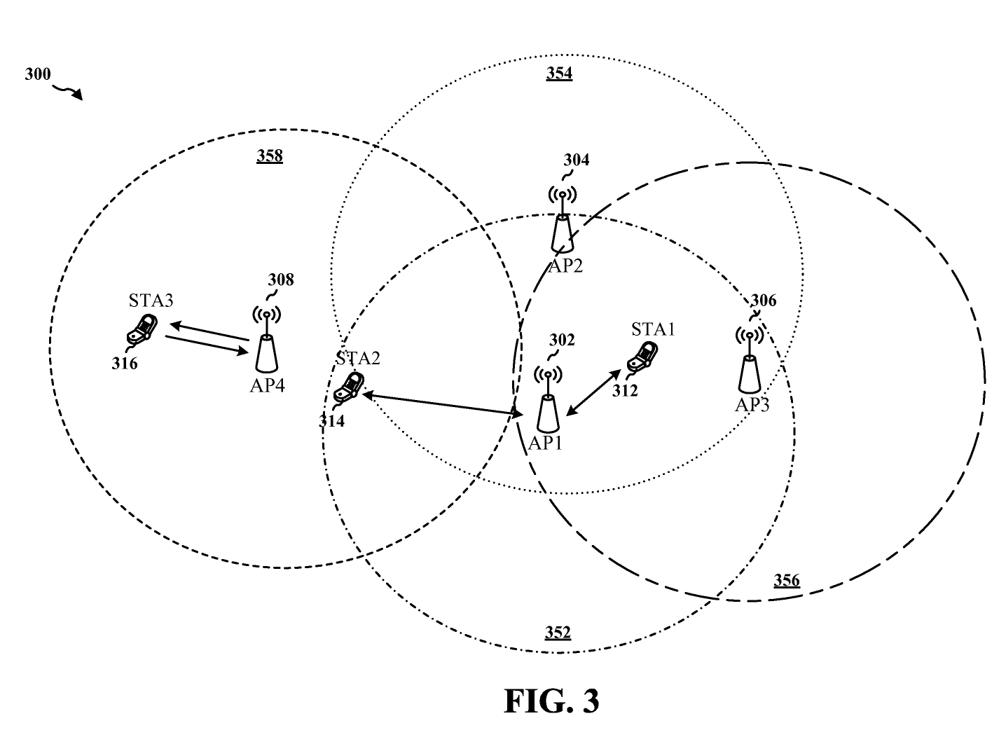

FIG. 3 is an example diagram 300 illustrating a wireless communication network including stations and access points. In FIG. 3, an access point 1 (AP1) 302 provides a first coverage area 352, an access point 2 (AP2) 304 provides a second coverage area 354, an access point 3 (AP3) 306 provides a third coverage area 356, and an access point 4 (AP4) 308 provides a fourth coverage area 358. A station 1 (STAT) 312 and a station 2 (STA2) 314 have established connection with the AP1 301, and are thus associated with the AP1 301. A station 3 (STA3) 316 is associated with AP4 308.

In an aspect, generally, a STA, especially a STA that is not associated with an AP, does not have information about which AP is suitable for association, and thus may attempt to associate with an AP that may not be suitable, and may experience failure in association or poor association. Therefore, an approach to provide such information to the STA such that the STA may select a suitable AP to associate is desired. In another aspect, generally, an AP does not report load information of the AP to a STA, where the load information of the AP may indicate how busy (e.g., loaded) the AP is. For example, depending on how loaded the AP is, the STA may determine to associate with the AP. Because APs generally do not report load information to a STA, the STA sends a probe request to each AP to obtain load information (e.g., basic service set (BSS) load information) of each AP. In response to the probe request from the STA, the AP may send a probe response including load information of the AP to the STA. Thus, to obtain load information of multiple APs, the STA generally sends multiple probe requests to respective APs and receive multiple probe responses from the respective APs. Further, several channels of operation may exist, and thus the STA may send a probe request at each channel, which may cause additional delays. Such procedure by the STA involving the probe requests and the probe responses may cause delays. In addition, there is no pre-association guidance on available neighbor APs and load information of the available neighbor APs. Thus, a procedure where the STA does not need to send multiple probe requests or receive multiple probe responses to retrieve the load information of APs is desired. For example, in a pre-associated state (e.g., before the STA associates with an AP), a new STA should be able to gather BSS load information without sending a probe request to each of the APs.

According to an aspect of the disclosure, a STA (e.g., a STA that is not associated with an AP) may initially gather information from each AP individually. Each AP may advertise respective information. In particular, the STA may receive AP association information from an AP, and determine whether to associate with the AP based on the received AP association information. The AP information from each AP provides information that the STA may use to determine whether to associate with a respective AP. In an aspect, the AP association information from the AP may include new association indication information and/or load information of the AP. The new association indication information of the AP indicates whether the AP accepts a new association with a station (e.g., STA). In an aspect, the new association information received from the AP may include duration information of the AP, where the duration information indicates a duration during which the AP is not accepting a new association with a station. In an aspect, the new association indication information may include a reason code associated with the new association indication information, where the reason code indicates one or more reasons for not accepting a new association with a station. Additional details on the new association indication information and the load information are provided infra.

In an aspect, the STA may receive fast initial link setup (FILS) indication information from the AP, where the FILS indication information includes security domain information and/or IP subnet information of the AP. The STA may determine whether to associate with the AP based on the FILS indication from the AP. The FILS indication information may be a FILS indication element (e.g., as specified in the IEEE 802.11ai specification). The AP may send the FILS indication information (e.g., FILS indication element) via at least one of a beacon frame, a probe response, or a FILS discovery frame. In such an aspect, the STA may further consider the FILS indication information from the AP to determine whether to associate with the AP. In an aspect, the FILS indication information from the AP may include the new association indication information and/or load information of the AP.

In another aspect, according to Task group ai (TGai) (e.g., according to the IEEE 802.11 specification, hereinafter “802.11 specification”), a TGai-enabled AP is capable of reporting a Reduced Neighbor Report (RNR) to a STA. Thus, in another aspect of the disclosure, a neighbor report such as the RNR in TGai may be modified to include load information (e.g., BSS load information) of an AP sending the RNR and other neighbor APs. The BSS load information may be included as an additional parameter in the RNR. The RNR may further include channels (e.g., channels used by an AP sending the RNR and other neighbor APs), target beacon transmission time (TBTT) for each of the channels, and BSS identifiers (IDs) of each of the APs. The RNR may further include information regarding a service set identifier (SSID) of the AP sending the RNR. For example, the RNR may include a short version (e.g., 4 bytes) of the SSID or a full version (e.g., 32 bytes) of the SSID. If the RNR includes the short version of the SSID, the short version of the SSID may be a 4-byte hash function (e.g., via cyclic redundancy check (CRC)). When a STA receives the RNR from an AP, the STA can receive the load information on the AP and other neighbor APs. Based on the load information on the AP and other neighbor APs, the STA may select an AP to associate, and establish connection with the selected AP. The RNR may be sent via at least one of a beacon frame, a probe response frame, or a FILS discovery frame when the AP has information about other neighbor APs. It is also noted that the STA may prioritize scanning of the channels based on the RNR.

An AP may be interested in gathering information about neighboring APs around the AP, and thus may request a STA (e.g., STA that is associated with the AP) to gather information about the surrounding APs. The STA associated with the AP may gather the load information of multiple APs surrounding the STA and send the load information of the multiple APs to an AP associated with the STA such that the associated AP may include the load information of the APs in an RNR. It is noted that a 802.11k beacon reporting approach may be used to gather information about surrounding APs in order to build a neighbor list of the surrounding APs. In particular, an AP associated with a STA may send a beacon request to the STA. The beacon request may include a BSS load information identifier to indicate that BSS load information should be gathered. For example, an information element (IE) field in a beacon request may be used to specify a type of information that the associated AP requests via beacon reporting. According to the 802.11 specification, for example, a request element in an Optional Subelements field of the beacon request may include one or more IEs that identify particular information to be gathered by the STA receiving the beacon request. Thus, for example, if the BSS load information identifier is the BSS load IE in the request element of the Optional Subelements field of the beacon request, the STA receiving the beacon request will gather BSS load information from the surrounding APs.

When the STA receives a beacon request including the BSS load information identifier from the associated AP, the STA starts gathering load information from each of surrounding APs around the STA to generate a report including the gathered load information of the surrounding APs. In one example, the STA may gather the load information from the surrounding APs by sending a probe request to each surrounding AP and receiving a probe response including the load information from each surrounding AP. In another example, the STA may gather the load information from the surrounding APs by passively listening on channels to retrieve the load information from the surrounding APs. Subsequently, the STA sends the report including the gathered load information of the surrounding APs to the associated AP that sent the beacon request to the STA. After receiving the report including the gathered load information of the surrounding APs, the associated AP includes the load information of the surrounding APs in the RNR. Thus, the associated AP may generate the RNR with the load information of the surrounding APs. When a new STA attempts to locate an AP to associate with, the new STA may obtain the RNR from the AP, and select an AP to associate based on the load information of the surrounding APs in the RNR.

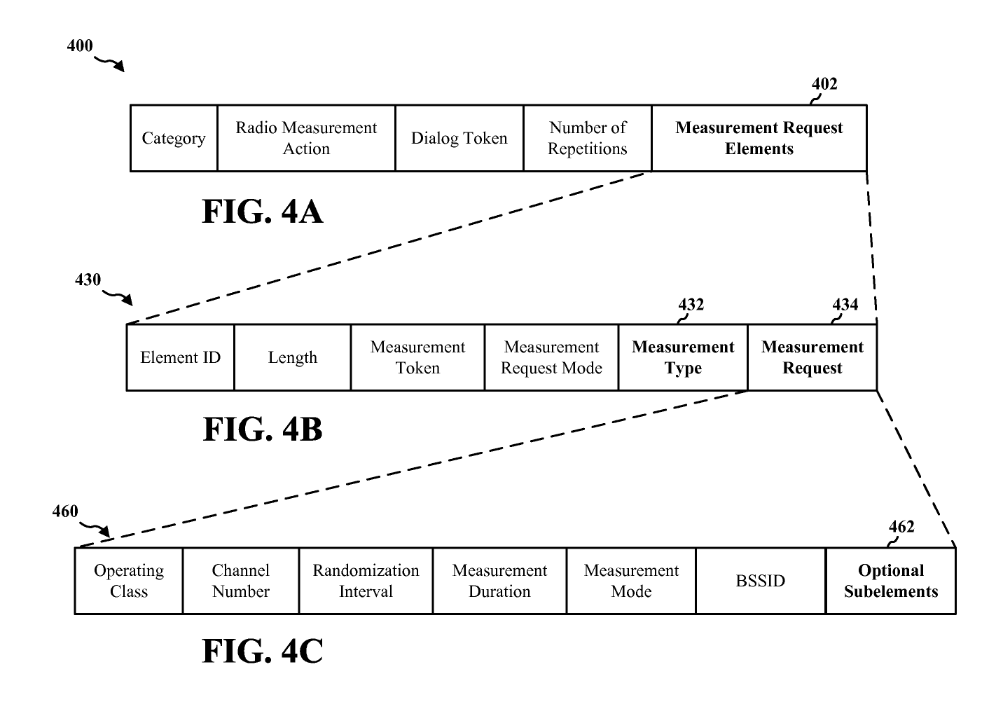

FIGS. 4A-4C are example diagrams illustrating an example structure of a beacon request. FIG. 4A is an example diagram 400 illustrating a structure of a radio measurement request frame. A measurement request elements 402 may be specified in the radio measurement request frame 400, which is illustrated more in detail in FIG. 4B. In the radio measurement request frame 400 of FIG. 4A, 1 octet may be allocated for the category, 1 octet may be allocated for the radio measurement action, 1 octet may be allocated for the dialog token, and 2 octets may be allocated for the number of repetitions. In the radio measurement request frame 400 of FIG. 4A, the number of octets allocated for the measurement request elements 402 may vary.

FIG. 4B is an example diagram 430 illustrating a structure of the measurement request elements 402. The structure 430 of the measurement request elements 402 shows that a measurement type field 432 may be specified. For a beacon request, the measurement type field 432 may be specified as a beacon request. According to the structure 430 of the measurement request elements 402 in FIG. 4B, 1 octet may be allocated for the element ID, 1 octet may be allocated for the length, 1 octet may be allocated for the measurement token, 1 octet may be allocated for the measurement request mode, and 1 octet may be allocated for the measurement type field 432. According to the structure 430 of the measurement request elements 402 in FIG. 4B, the number of octets allocated for the measurement request field 434 may vary. A measurement request field 434 may be specified according to the structure illustrated in FIG. 4C.

FIG. 4C is an example diagram 460 illustrating a structure of the measurement request field 434. The structure 460 of the measurement request field 434 shows that an optional subelements field 462 may be specified. The optional subelements field 462 is associated with a request element. The request element specifies a type of AP information to be gathered by a STA receiving the beacon request. For example, if the request element includes a BSS load IE, then the STA receiving the beacon request will gather BSS load information from surrounding APs. If the request element does not include any IDs, the STA will gather basic information from the surrounding APs, such as AP identifiers. According to the structure 460 of the measurement request field 434 in FIG. 4C, 1 octet may be allocated for the operating class, 1 octet may be allocated for the channel number, 2 octets may be allocated for the randomization interval, 2 octets may be allocated for the measurement duration, 1 octet may be allocated for the measurement mode, and 6 octets may be allocated for the BSS identifier (BSSID). According to the structure 460 of the measurement request field 434 in FIG. 4C, the number of octets allocated for the optional subelements field 462 may vary.

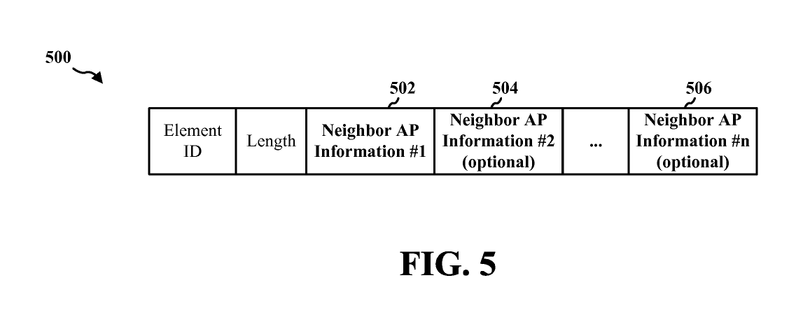

FIG. 5 is an example diagram 500 illustrating an example structure of a neighbor report. As illustrated in FIG. 5, the neighbor report 500 may carry neighbor AP information 502 of AP #1, neighbor AP information 504 of AP #2, and neighbor AP information 506 of AP #n. Thus, the neighbor report 500 may carry AP information on one or more APs. As discussed above, an AP receives AP information of the surrounding APs from a STA associated with the AP and then generates the neighbor report 500 that includes the AP information 502, 504, and 506 of the surrounding APs. For example, the neighbor AP information may include BSS load information of the APs and/or fast initial link setup (FILS) indication information of the APs. In the neighbor report 500 of FIG. 5, 1 octet may be allocated for the element ID and 1 octet may be allocated for the length. In the neighbor report 500 of FIG. 5, the number of octets allocated for each of the neighbor AP information 502 of AP #1, the neighbor AP information 504 of AP #2, and the neighbor AP information 506 of AP #n may vary.

It is noted that the AP may send a beacon request to multiple STAs that are associated with the AP. For example, referring back to FIG. 3, the AP1 302 may send a beacon request to the STA 1 312 and the STA2 314. The APs surrounding the STA 1 312 are the AP1 302, the AP2 304, and the AP3 306. The APs surrounding the STA2 314 are the AP1 302, the AP2 304, and the AP4 308. The STAT 312 may include information about the AP1 302, the AP2 304, and the AP3 306 in a beacon report, and the STA2 314 may include information about the AP1 302, the AP2 304, and the AP4 308. Thus, by sending beacon requests to multiple STAs, the AP may receive information about more APs than when the AP sends a beacon request to a single STA.

In another aspect, an approach to gather TBTT information of surrounding APs (e.g., to include the TBTT information in the RNR) has not been currently developed. Further, the RNR generally does not provide information about security domain information or IP subnet information of the APs. It is noted that the STA may utilize the security domain information or IP subnet information of the APs to select an AP with which to associate. For example, if a STA has association with a service provider, then it would like to select an AP whose security domain and/or IP subnet information matches the service provider.

To address the above issue, the RNR in TGai may be modified to include FILS indication information of an AP (e.g., AP sending the RNR) and other neighbor APs included in the RNR, where the FILS indication information includes security domain information and IP subnet information of the AP sending the RNR and the neighbor APs. For example, the FILS indication information may be included as an additional parameter in the RNR that is sent from the AP to the STA. Thus, when a STA receives the RNR from an AP, the STA can receive the security domain information and IP subnet information on the AP and other neighbor APs. It is noted that a 802.11k beacon reporting approach may be used to gather the FILS indication information. In particular, an AP associated with a STA may send a beacon request to the STA, where the beacon request may include FILS indication information identifier (e.g., FILS indication IE) to indicate that FILS indication information should be gathered. Thus, for example, if the FILS indication identifier is a FILS indication IE in the request element of the Optional Subelements field of the beacon request, the STA receiving the beacon request will gather FILS indication from the surrounding APs When the STA receives a beacon request including the FILS indication information identifier from the associated AP, the STA starts gathering FILS indication information from each of surrounding APs around the STA to generate a report including the gathered FILS indication information of the surrounding APs. It is noted that the STA may not gather FILS indication from all of the surrounding APs at least because not all APs may be TGai-enabled. Subsequently, the STA sends the report including the gathered FILS indication information of the surrounding APs to the associated AP that sent the beacon request to the STA. After receiving the report including the gathered FILS indication information of the surrounding APs, the associated AP includes the FILS indication information of the surrounding APs in the RNR. Thus, the associated AP may generate the RNR with the FILS indication information of the surrounding APs.

The STA may utilize the beacon reporting to obtain TBTT information of the surrounding APs. In particular, the STA may receive a beacon message from each of the surrounding APs, where the beacon message includes time information such as a beacon interval and a timestamp (e.g., current time). The STA may determine the TBTT information based on the beacon interval and a time stamp, for example, by adding the beacon interval to the time stamp. For example, if the beacon interval is 10 minutes, and the timestamp indicates the current time of 9:00 am, then the station determines that the next TBTT is 9:10 am by adding 10 minutes to 9:00 am. The STA subsequently sends the TBTT information of the surrounding APs to the AP associated with the STA, such that the AP associated with the STA may generate the RNR that includes the TBTT information of the surrounding APs.

In another aspect, although an AP may indicate how loaded the AP is (e.g., by advertising BSS load information), the AP generally does not provide information to the AP's clients (STAs) whether the AP can support an additional client (e.g., whether the AP can associate with a new client). The STA may be able to determine how loaded the AP is (e.g., by receiving the BSS load information). However, because the STA cannot determine whether the AP can support an additional client, the STA may still try associating with the AP even if the AP is heavily loaded, and may be rejected by the AP that is heavily loaded. Accordingly, inability to determine whether the AP can accept an additional client may increase association time for the STA and may cause unnecessary messaging between the AP and the STA which occupies air time that may be used for the AP's associated clients.

To address the above issues, an AP may include its own new association indication information that indicates whether the AP accepts an additional client, and may be configured to send the new association indication information to the STA. The AP may send, to the STA, the new association indication information via at least one of a beacon probe response, a unicast transmission, or a broadcast transmission. For example, the AP may send the new association indication information via at least one of beacon frames, probe response frames, or (re)association response frames. In an aspect, the AP may further send, to the STA, duration information of the AP, where the duration information indicates a duration during which the AP is not accepting a new association with a station. In an aspect, the AP may further send, to the STA, a reason code associated with the new association indication information, where the reason code indicates one or more reasons for not accepting a new association with a station. In an aspect, the duration information and/or the reason code may be sent in the same frame as the frame in which the new association indication is sent. In an aspect, for example, the RNR in TGai may be modified to include new association indication information of an AP sending the RNR and other neighbor APs.

In one approach, the new association indication information may be included as a new field in the FILS indication information of the AP sending the RNR and other neighbor APs. If FILS indication information is used to include the new association indication information, a 802.11k beacon reporting approach that is similar to the beacon reporting approach for the FILS indication information as discussed above may be utilized. Thus, as discussed above, an AP associated with a STA may send a beacon request to the STA, where the beacon request may include FILS indication information identifier (e.g., FILS indication IE) to indicate that FILS indication information should be gathered. When the STA receives a beacon request including the FILS indication information identifier from the associated AP, the STA starts gathering FILS indication information from each of surrounding APs around the STA to generate a report including gathered FILS indication information of the surrounding APs. Subsequently, the STA sends the report including the gathered FILS indication information of the surrounding APs to the associated AP that sent the beacon request to the STA. After receiving the report including the gathered FILS indication information of the surrounding APs, the associated AP includes the FILS indication information of the surrounding APs in the RNR. When a new STA receives the RNR including the FILS indication information, the new STA may use the new association indication information included in the FILS indication information to determine whether to associate with a particular AP. In particular, if the STA determines that an AP does not accept an additional client based on the new indication information, the STA refrains from attempting to associate with the AP.

In another approach, the new association indication information may be used without including the new association indication information in the FILS indication information. The 802.11k beacon reporting approach may be used to gather the new association indication information. In particular, an AP associated with a STA may send a beacon request to the STA, where the beacon request may include new association indication identifier (e.g., new association indication IE) to indicate that new association indication information should be gathered. When the STA receives a beacon request including the new association indication identifier from the associated AP, the STA starts gathering new association indication information from each of surrounding APs around the STA to generate a report including the gathered new association indication information of the surrounding APs. Subsequently, the STA sends the report including the gathered new association indication information of the surrounding APs to the associated AP that sent the beacon request to the STA. When a new STA receives the RNR including the FILS indication information, the new STA may use the new indication information to determine whether to associate with a particular AP.

In another aspect, the STA may send channel information to the AP, where the channel information indicates to the AP what channel(s) or band(s) the station supports. For example, the STA may send channel information to the AP, where the message indicates that the station supports operation on channels in 2.5 GHz and 5 GHz bands. The AP provides guidance information to the STA, regardless of whether the STA is associated with AP or not. In one aspect, the guidance information may be used to guide the STA to connect to a specific AP. In one aspect, the guidance information may include a list of other APs in the neighborhood surrounding the AP and may further include priorities respectively associated with the other APs. The AP may generate guidance information based on the information that the STA provides to the AP. In an aspect, the STA may provide network connectivity information indicating one or more types of network connections supported by the STA, and the guidance information may be generated based on the network connectivity information. For example, one station may provide network connectivity information indicating that the STA supports a CDMA and WLAN connections, and the AP generates guidance information to guide the STA to an AP that supports such connections for association with the STA. When the STA receives the guidance information from the AP, the STA may determine to associate with one of the APs based on the guidance information.

The channel information may further include preference codes respectively associated with the supported channels indicated in the channel information. The preference codes indicate priorities for the channels. In an aspect, the supported channels may be associated with different numbers as the preference codes. For example, a supported channel with higher priority may be associated with a higher number and a supported channel with lower priority may be associated with a lower number. In such an example, a supported channel associated with 1 as the preference code may have a lower priority than a supported channel associated with 2 as the preference code. In an aspect, the guidance information includes at least one of load information, security information, IP subnet information, new association indication information with respect to the APs.

In another aspect, a new STA that is not associated with an AP generally starts scanning in a specific order to determine an AP to associate with the new STA. Because the APs are generally listed in a specific order in the RNR, the new STA would follow the set order of the APs in scanning for an AP to associate. If the new STA finds an AP that satisfies the new STA's criteria, the new STA will attempt to associate with the AP that satisfies the criteria. Examples of the criteria include IP subnet information, security domain information, new association indication, and etc. Hence, the first AP on the list of the set order of APs that satisfies the criteria is generally associated with the new STA. Therefore, APs that are listed in the beginning (and satisfy the criteria) of the set order are selected more frequently than APs that are listed later. As a result, the APs that are listed in the beginning of the set order may become loaded quickly while the APs listed near the bottom are not loaded. Especially in a crowded location with many clients, the new STA's scan of the APs in the set order and association according to the set order may burden APs listed in the beginning of the RNR list.

To address the above issue, a new STA randomizes the AP scan order (e.g., an order of channels to scan for APs) based on a media access control (MAC) address associated with the new AP (e.g., via a hash of the MAC address), where the new STA is a STA that is not yet associated with an AP. For example, a new STA may utilize the MAC address of the new STA and derive an order of channels based on the new STA's MAC address. For example, the new STA may enter a MAC address of the new STA into a hash function, which subsequently outputs the order of the channels. It is noted that the AP scan order may be mapped with the hash of the MAC address. The mapping between the scan order and the hash of the MAC address may be pre-defined and embedded in all compliant STAs or may be computed with an algorithm and/or calculation. As each of STAs randomizes the AP scan order based on a MAC address of a corresponding STA, at least several of the STAs may have different scan orders from each other. It is noted that the randomized order of the channels may be changed periodically or may stay the same, in one example.

In another aspect, a STA at a fringe (e.g., edge) of a coverage area of an AP may consume unnecessary time and/or resources by attempting to associate with the AP whose coverage area does not completely cover the STA. For example, referring back to FIG. 3, the STA2 may be considered to be at a fringe of the first coverage area 352 because the STA2 314 is at an edge of the first coverage area 352. The STA at the fringe of the AP's coverage area may also affect STAs that are already associated with the AP because the AP spends time and/or resources to attempt to serve the STA at the fringe. Therefore, the AP should avoid association with a fringe STA to avoid weak signal reception, and the likelihood of disconnecting from the AP, etc.

One approach to address the above issues is to advertise association criteria by an AP via a beacon message and/or a probe response. The association criteria may include a threshold for a signal strength parameter such as a received channel power indicator (RCPI) and a received signal strength indicator (RSSI). Thus, an AP may send a beacon message and/or a probe response including a signal strength threshold to a STA. If the STA determines that signal strength (e.g., an RCPI or an RSSI) of the beacon message and/or the probe response is less than the signal strength threshold included in the beacon message and/or the probe response, the STA does not associate with the AP. It is noted that the AP may not respond to a probe request sent from the STA if a signal of the probe request does not satisfy the association criteria (e.g., RCPI/RSSI signal strength threshold). If a STA attempts to associate with an AP by sending an association request to the AP and signal strength of the association request is below the signal strength threshold, the AP may reject the association request by sending an association reject message with a status code indicating that the signal strength criteria was not satisfied. The status code sent with the association reject message may include suggested BSS transition indicating one or more candidate APs that the STA may associate. The association reject message may further include information on the difference (e.g., in dB) between the signal strength (e.g., RSSI) measured by the AP and the signal strength threshold (e.g., minimum RSSI sufficient for association), and/or an information on the minimum time period for the STA to wait to send another association request to the AP. If the STA receives the association reject message from the AP, the STA may not reattempt association with the AP until the minimum time period has expired. The STA may determine that the AP will accept an association request if the signal strength is at least the signal strength threshold.

Another approach to address the above issue is to modify the RNR in TGai to include FILS indication information of an AP sending the RNR and other neighbor APs, where the FILS indication information includes signal strength thresholds of the AP sending the RNR and the neighbor APs. If FILS indication information is used to include the new association indication information, a 802.11k beacon reporting approach that is similar to the beacon reporting approach for the FILS indication information as discussed above may be utilized. Thus, as discussed above, an AP associated with a STA may send a beacon request to the STA, where the beacon request may include FILS indication information identifier (e.g., FILS indication IE) to indicate that FILS indication information should be gathered. When the STA receives a beacon request including the FILS indication information identifier from the associated AP, the STA starts gathering FILS indication information from each of surrounding APs around the STA to generate a report including the gathered FILS indication information of the surrounding APs. Subsequently, the STA sends the report including the gathered FILS indication information of the surrounding APs to the associated AP that sent the beacon request to the STA. After receiving the report including the gathered FILS indication information of the surrounding APs, the associated AP includes the FILS indication information of the surrounding APs in the RNR. When a new STA receives the RNR including the FILS indication information, the new STA may use the signal strength thresholds of the surrounding APs included in the FILS indication information to determine whether to associate with a particular AP. Use of a signal strength threshold in determining whether to form association between a STA and an AP is as discussed above.

In another aspect, according to a current implementation, after a STA associates with an AP, the STA may stay with the same AP for an extended period of time without handing off to another AP, even if a data rate of the currently associated AP is low and other APs are available for a handover. For example, a STA with low modulation coding scheme (MCS) with a low data rate may stay with the AP for an extended period of time. It may be undesirable to continue to stay with the same AP, especially if there are other available APs that may provide a better data rate than the current AP.

To address the above issue, each AP may set a supported data rate and/or a data rate per bandwidth (e.g., via a data rate threshold), such that a STA will switch to another AP if the data rate is below the set data rate threshold. In an example, the AP may send, to the STA associated with the AP, information via (re)association response frames and/or a downlink signal strength threshold (e.g., a minimum RSSI threshold for the STA to initiate a BSS transition). In an implementation example, in order to switch to another AP, the STA may initiate a 802.11v based BSS Transitions by sending a BSS Transition Management Query to the AP with a new reason code indicating low MCS or a reason code that indicates a low RSSI. In particular, in a BSS transition query frame, there is a reason code to indicate to the AP why the STA is requesting transition. The reason code may be used to indicate low MCS or low RSSI. The BSS Transition Management Query may also include a BSS Transition Candidate list with BSS Candidate Preference values based on evaluation of each of the surrounding APs. For example, the BSS Candidate Preference values may be determined based on a combination of one or more values associated with a security domain, IP subnet, a new association indication, BSS load information, RCPI, etc. It is noted that the STA may obtain such information about surrounding APs either via a modified RNR (as discussed above), or the STA can query the surrounding APs to obtain information about the surrounding APs.

The STA may fail to switch to another AP even if a data rate (e.g., an MCS or RCPI/RSSI) of the STA drops below a set data rate threshold. In such a case, if the STA fails to respond within a certain waiting time after the data rate of the STA drops below the set data rate threshold, the AP may initiate a BSS Transition and disassociate the STA with appropriate reason code. In particular, after the waiting time expires, the AP may initiate disassociation with the current STA, and send a transition request to the STA such that the STA may switch to another AP upon receiving the transition request. In an implementation example, an AP may initiate 802.11v BSS Transition by sending a BSS Transition Management Request frame to the STA after a data rate of the STA drops below a set data rate threshold (e.g., an MCS criteria or RCPI/RSSI criteria). The transition request may include a disassociation timer and a list of candidate APs that the STA may transition to. In particular, the STA starts disassociating with the current AP after the disassociation timer expires. It is noted that the list of candidate APs may be built based on a 802.11k beacon reporting technique. The transition request may include a back-off period, which is a time period during which the STA will refrain from attempting to reassociate with the AP that the STA disassociated from. In particular, after the STA disassociates from the AP, the STA does not attempt to associate with the same AP at least until the back-off period expires.

In one aspect, to request the STA to transition to another BSS (or to another base band or channel, or to transfer to a cellular network), the AP associated with the STA (e.g., a serving AP of the STA) may send a transition request to the STA. The transition request may include a transition reason code with values for at least one of load balancing, signal quality, interference, a priority service, or assigned channel usage. If a preferred transition in the transition request is for transferring to a cellular network, the transition request may include an indication that the preferred transition is for the STA to transfer to a cellular network. The transition request may not include such indication to a STA that is not capable of communicating with a cellular network. The transition request may include a list of candidate BSSs to which the STA may transition. The AP transition request may provide a preference ranking (e.g., by assigning priority to each candidate BSS on the list) to the STA. When the STA receives the transition request, the STA may send a response to the AP. The response may include a status code field to indicate whether the transition request is accepted or rejected, and, if the transition request is rejected, the response may include a reason for the rejection. The response may include a BSS identifier of the BSS to which the STA is trying to transition. The response may include a list of candidate BSSs collected by the STA during scanning. When the STA transitions to another BSS, the STA minimizes the impact of the BSS transition (e.g., fewer over-the-air frames and extensible authentication protocol (EAP) messages) on the network and the STA.

In another aspect, in order to direct the STA to transition to another BSS (or to another base band or channel, or to transfer to a cellular network), the AP associated with the STA (e.g., a serving AP of the STA) may send an unsolicited mandate to the STA. The mandate may include a transition reason code with values for at least one of load balancing, signal quality, interference, a priority service, or assigned channel usage. If a preferred transition in the transition request is for transferring to a cellular network, the mandate may include an indication that the preferred transition is for the STA to transfer to a cellular network. The mandate may include a minimum waiting time before the STA performs a reconnection attempt to the serving AP. If the mandate includes such a minimum waiting time, the STA refrains from attempting to associate with the AP until expiration of the minimum waiting time period. The mandate may include an indication that indicates whether the AP is leaving a current band and/or channel. The mandate may include an indication that indicates whether the STA will be disassociated from the current BSS. The mandate may include a time after which the AP may dissociate with the STA. The mandate may not include such indication to a STA that is not capable of communicating with a cellular network. The mandate may include a list of candidate BSSs to which the STA may transition. The mandate may provide a preference ranking (e.g., by assigning priority to each candidate BSS on the list) to the STA. When the STA receives the mandate, the STA may respond to request a disassociation delay or to provide other information to the AP.

In an implementation example, various reason codes may be utilized according to the 802.11 specification as reason codes for disassociation from an AP. For example, Code 34 indicates that the STA disassociates from the AP because excessive number of frames need to be acknowledged, but are not acknowledged due to AP transmissions and/or poor channel conditions. For example, Code 33 indicates that the STA disassociates from the AP because a quality of service (QoS) AP lacks sufficient bandwidth for this QoS STA. A new reason code may be added to indicate that the disassociation occurred because RCPI/RSSI criteria are not met. Another new reason code may be added to indicate that the disassociation occurred because MCS criteria are not met.

In another aspect, when a STA receives a request to make measurements of surrounding APs, the STA may not be available to make such measurements although the STA is capable of making such measurements. For example, the STA may be too busy to make measurements when the STA receives the request to make the measurements. In a current 802.11k specification, the Measurement Report Element has an incapability indication (e.g., the STA being incapable of measuring) or a refusal indication (e.g., the STA refusing to make measurements). In such a case where the STA is not available to make measurements, it may be desirable to defer such measurements so that the STA may perform the measurements when the STA becomes available (e.g., becomes less busy) to make such measurements. However, the current 802.11k specification does not include any indication for deferral of measurements.

To address the above issue, an aspect of the disclosure provides a deferral feature such that the AP may wait for some time before sending another measurement report. For example, a measurement report sent by a STA may be modified to include a deferral indication to indicate that the STA is capable and willing to do the requested measurements but after a specified deferral time. The measurement report may further include a deferral time to indicate duration of time for deferral. After receiving the deferral indication from the STA, the AP may wait for the deferral time and then send another measurement report to the STA after the deferral time has passed.

In one implementation example, Measurement Report Element in the 802.11k specification may be modified to include a defer sub-field in the Measurement Report Mode field for such deferral indication (e.g., at one of the Reserved bits from bit 3-7). See, for example, Table 1 and Table 2 below. In such an example, no other bit in the Measurement Report Mode field will be set when the defer sub-field is set (e.g., Late (bit0), Incapable (bit1) and Refuse (bit2) shown in Table 2 will be 0 when Defer=1).

TABLE 1
Measurement Report Element format

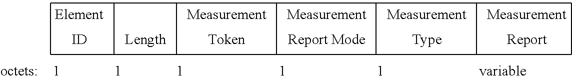

TABLE 2
Measurement Report Mode field

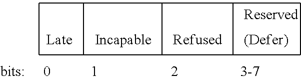

In another aspect, a current 802.11 specification describes a status code 82 that indicates “Rejected with Suggested BSS Transition.” An AP may send a STA the status code 82 included in the AP's Association Response or Reassociation Response rejecting STA's association attempt. When BSS transition is performed at a STA, the BSS transition generally assumes that a STA is already associated with an AP. However, the status code 82 indicating “Rejected with Suggested BSS Transition” may not be consistent with the STA that has not yet associated with an AP. Thus, although “Rejected with Suggested BSS Transition” indication requests the STA to perform BSS transition, such indication is valid only if the STA is already associated with an AP. It is noted that the current specification does not describe how the STA will carry out BSS transition in pre-associated state (before the STA associates with an AP), and does not provide information on candidate APs for the BSS transition.

To address the above issues, an association response or a reassociation response from an AP is modified to include one or more Neighbor Report elements as BSS transition candidate list entries when the status code is 82 indicating “Rejected with Suggested BSS Transition”. In particular, when a STA sends an association request to an AP, the AP may respond with an association response or a reassociation response that includes the “Rejected with Suggested BSS Transition” indication including BSS transition candidate list entries. The BSS transition candidate list entries include a list of BSS transition candidate APs with which the STA may attempt to associate. Subsequently, the STA may select an AP among the candidate APs based on the BSS transition candidate list, and may perform BSS transition to associate with the selected AP.

In an aspect, when a STA receives a request to make measurements of APs, the STA may receive AP metrics transmitted from each of the APs. The STA may estimate connectivity key performance indicators (KPIs) of the APs based on the AP metrics. The STA may estimate the connectivity KPIs of the APs further based on a process by the STA. The connectivity KPIs may include throughput and/or access latency. The connectivity KPIs relate to connectivity at a service access point. It is noted that the STA may obtain the information in the connectivity KPIs by associating with an AP. The STA may select an AP to associate among the APs based on the AP metrics and a process by the STA (e.g., measuring an RSSI and interferences). The AP metrics are known by a corresponding AP and may include information about channel utilization and/or current traffic characteristics. It is noted that the STA may use the AP metrics to evaluate connectivity KPIs for an AP that is currently associated with the STA. It is also noted that the AP metrics may be used for network selection between a cellular network and WiFi network and/or for network selection between multiple WiFi networks.

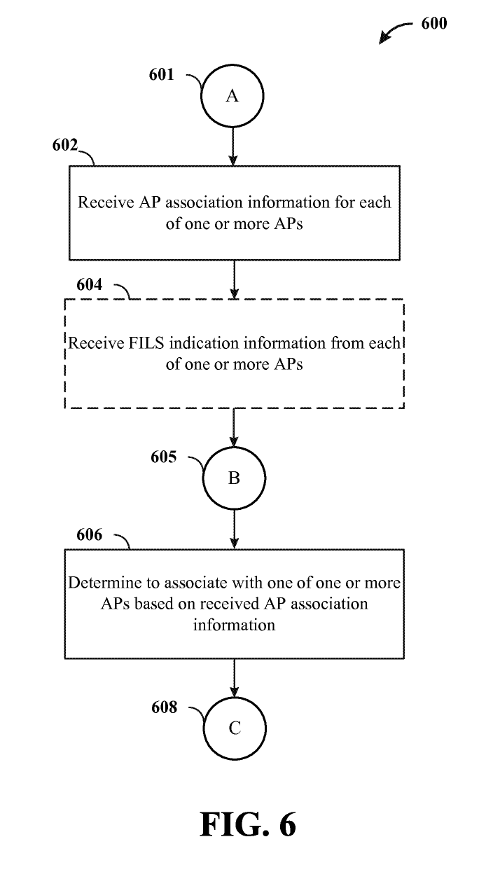

FIG. 6 is a flowchart of an example method 600 of wireless communication according to an aspect. The method 600 may be performed using an apparatus (e.g., the wireless device 202 of FIG. 2, for example). The apparatus may be implemented as a STA 116, for example. Although the process 600 is described below with respect to the elements of wireless device 202 of FIG. 2, other components may be used to implement one or more of the steps described herein.

At block 602, the apparatus may receive AP association information for each of one or more APs. In an aspect, the AP association information for each of the one or more APs may include at least one of new association indication information or load information of a corresponding AP of the one or more APs. The new association indication information indicates whether the corresponding AP of the one or more APs accepts a new association with a station. In an aspect, the new association indication information includes duration information of a corresponding AP of the one or more APs. The duration information indicates a duration during which the corresponding AP of the one or more of APs is not accepting a new association with a station. In an aspect, the new association indication information includes a respective reason code associated with the new association indication information. The reason code may indicate one or more reasons for the AP not accepting a new association with a station.

In an aspect, at block 604, the apparatus may receive FILS indication information from each of the one or more APs. The FILS indication information of a corresponding AP of the one or more APs may include at least one of security domain information or IP subnet information of the corresponding AP of the one or more APs. At block 606, the apparatus may determine to associate with one of the one or more APs based on the received AP association information. At block 608, the apparatus may continue with additional method features. In an aspect, the determination to associate with one of the one or more APs is further based on the FILS indication information. In an aspect, the FILS indication information from each of the one or more APs includes at least one of new association indication information or load information of a corresponding AP of the one or more APs.

For example, as discussed supra, the STA may receive AP association information from an AP, and determine whether to associate with the AP based on the received AP association information. For example, as discussed supra, the AP association information from the AP may include new association indication information and/or load information of the AP. For example, as discussed supra, the new association information received from the AP may include duration information of the AP, where the duration information indicates a duration during which the AP is not accepting a new association with a station. For example, as discussed supra, the new association indication information may include a reason code associated with the new association indication information, where the reason code indicates one or more reasons for not accepting a new association with a station. For example, as discussed supra, the AP may receive FILS indication information from the AP, where the FILS indication information includes security domain information and/or IP subnet information of the AP. For example, as discussed supra, the AP may further consider the FILS indication information from the AP to determine whether to associate with the AP.

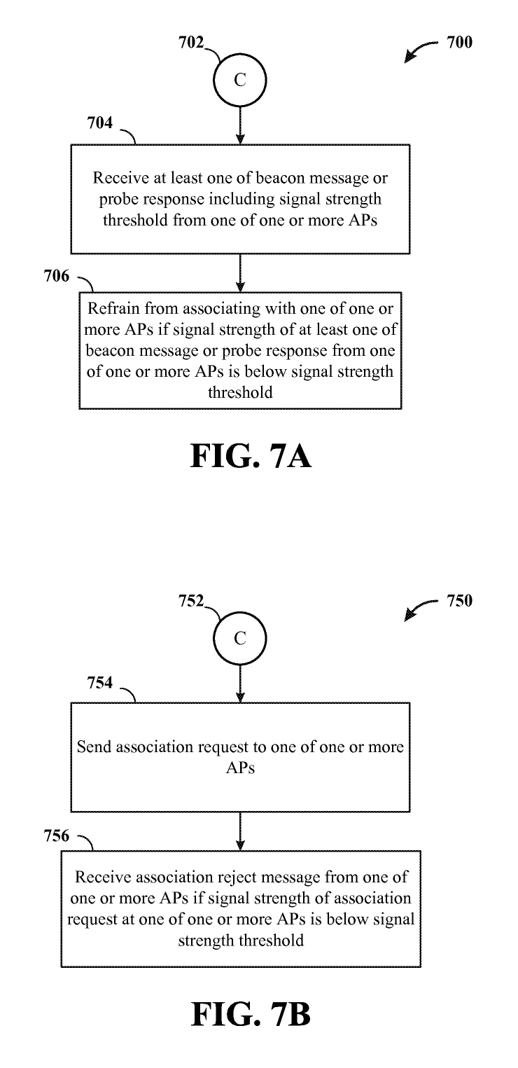

FIG. 7A is a flowchart of an example method 700 of wireless communication expanding from the aspect illustrated in FIG. 6. The method 700 may be performed using an apparatus (e.g., the wireless device 202 of FIG. 2, for example). The apparatus may be implemented as a STA 116, for example. Although the process 700 is described below with respect to the elements of wireless device 202 of FIG. 2, other components may be used to implement one or more of the steps described herein.

At block 702, the method 700 continues from block 608 of the method 600 of FIG. 6. At block 704, the apparatus may receive at least one of a beacon message or a probe response including a signal strength threshold from one of the one or more APs. At block 706, the apparatus may refrain from associating with the one of the one or more APs if signal strength of the at least one of the beacon message or the probe response from the one of the one or more APs is below the signal strength threshold. For example, as discussed supra, an AP may send a beacon message and/or a probe response including a signal strength threshold to a STA. For example, as discussed supra, if the STA determines that signal strength (e.g., an RCPI or an RSSI) of the beacon message and/or the probe response is less than the signal strength threshold included in the beacon message and/or the probe response, the STA does not associate with the AP.

FIG. 7B is a flowchart of an example method 750 of wireless communication expanding from the aspect illustrated in FIG. 6. The method 750 may be performed using an apparatus (e.g., the wireless device 202 of FIG. 2, for example). The apparatus may be implemented as a STA 116, for example. Although the process 750 is described below with respect to the elements of wireless device 202 of FIG. 2, other components may be used to implement one or more of the steps described herein.

At block 752, the method 750 continues from block 608 of the method 600 of FIG. 6. At block 754, the apparatus may send an association request to one of the one or more APs. At block 756, the apparatus may receive an association reject message from the one of the one or more APs if signal strength of the association request at the one of the one or more APs is below a signal strength threshold. In an aspect, the association reject message includes a suggested BSS transition. For example, as discussed supra, if a STA attempts to associate with an AP by sending an association request to the AP and signal strength of the association request is below the signal strength threshold, the AP may reject the association request by sending an association reject message with a status code indicating that the signal strength criteria was not satisfied. For example, as discussed supra, the status code sent with the association reject message may include suggested BSS transition indicating one or more candidate APs that the STA may associate.

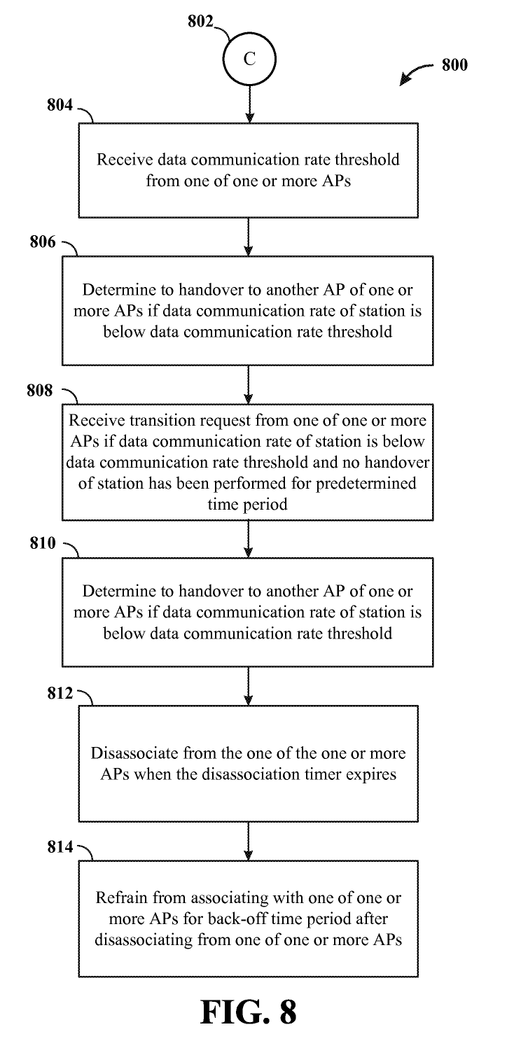

FIG. 8 is a flowchart of an example method 800 of wireless communication expanding from the aspect illustrated in FIG. 6. The method 700 may be performed using an apparatus (e.g., the wireless device 202 of FIG. 2, for example). The apparatus may be implemented as a STA 116, for example. Although the process 800 is described below with respect to the elements of wireless device 202 of FIG. 2, other components may be used to implement one or more of the steps described herein.

At block 802, the method 800 continues from block 608 of the method 600 of FIG. 6. At block 804, the apparatus may receive a data communication rate threshold from one of the one or more APs. At block 806, the apparatus may determine to handover to another access point of the one or more APs if a data communication rate of the apparatus is below the data communication rate threshold. At block 808, the apparatus may receive a transition request from the one of the one or more APs if the data communication rate of the apparatus is below the data communication rate threshold and no handover of the apparatus has been performed for a predetermined time period. In an aspect, the data communication rate is indicated by an MCS of the apparatus, and the data communication rate threshold is a threshold MCS at a specific bandwidth. At block 810, the apparatus may determine to perform a handover from the one of the one or more APs to another AP of the one or more APs in response to receiving the transition request. In an aspect, the transition request is a BSS Transition Request as specified in an IEEE 802.11 specification. At block 812, where the transition request includes a disassociation timer, a back-off timer, and a list of candidate APs for a handover, the apparatus may disassociate from the one of the one or more APs when the disassociation timer expires. At block 814, the apparatus may refrain from associating with the one of the one or more APs for a time period of the back-off timer after disassociating from the one of the one or more APs.

For example, as discussed supra, each AP may set a supported data rate and/or a data rate per bandwidth (e.g., via a data rate threshold), such that a STA will switch to another AP if the data rate is below the set data rate threshold. For example, as discussed supra, in order to switch to another AP, the STA may initiate a 802.11v based BSS Transitions by sending a BSS Transition Management Query to the AP with a new reason code indicating low MCS or a reason code 16 that indicates a low RSSI. For example, as discussed supra, the BSS Transition Management Query may also include a BSS Transition Candidate list with BSS Candidate Preference values based on evaluation of each of the surrounding APs. For example, as discussed supra, after the waiting time expires, the AP may initiate disassociation with the current STA, and send a transition request to the STA such that the STA may switch to another AP upon receiving the transition request. For example, as discussed supra, an AP may initiate 802.11v BSS Transition by sending a BSS Transition Management Request frame to the STA after a data rate of the STA drops below a set data rate threshold. For example, as discussed supra, the transition request may include a disassociation timer and a list of candidate APs that the STA may transition to. For example, as discussed supra, the STA starts disassociating with the current AP after the disassociation timer expires. For example, as discussed supra, after the STA disassociates from the AP, the STA does not attempt to associate with the same AP at least until the back-off period expires.

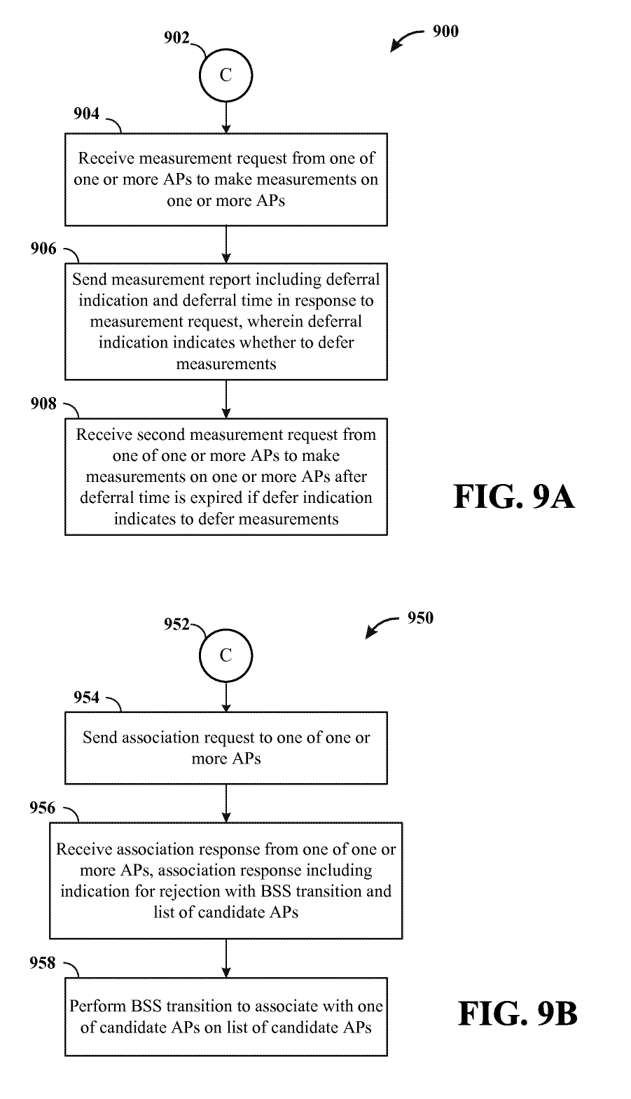

FIG. 9A is a flowchart of an example method 900 of wireless communication expanding from the aspect illustrated in FIG. 6. The method 1400 may be performed using an apparatus (e.g., the wireless device 202 of FIG. 2, for example). The apparatus may be implemented as a STA 116, for example. Although the process 1400 is described below with respect to the elements of wireless device 202 of FIG. 2, other components may be used to implement one or more of the steps described herein.

At block 902, the method 900 continues from block 608 of the method 600 of FIG. 6. At block 904, the apparatus may receive a measurement request from one of the one or more APs that the apparatus is associated with to make measurements on the one or more APs. At block 906, the apparatus may send a measurement report including a deferral indication and a deferral time in response to the measurement request, where the deferral indication indicates whether to defer the measurements. In an aspect, the measurements on the one or more APs are deferred for the deferral time if the deferral indication indicates to defer the measurements. At block 908, the apparatus may receive a second measurement request from the one of the one or more APs that the apparatus is associated with to make measurements on the one or more APs after the deferral time is expired if the deferral indication indicates to defer the measurements.

For example, as discussed supra, a measurement report sent by a STA may be modified to include a deferral indication to indicate that the STA is capable and willing to do the requested measurements but after a specified deferral time. For example, as discussed supra, the measurement report may further include a deferral time to indicate duration of time for deferral. For example, as discussed supra, after receiving the deferral indication from the STA, the AP may wait for the deferral time and then send another measurement report to the STA after the deferral time has passed.

FIG. 9B is a flowchart of an example method 950 of wireless communication expanding from the aspect illustrated in FIG. 6. The method 950 may be performed using an apparatus (e.g., the wireless device 202 of FIG. 2, for example). The apparatus may be implemented as a STA 116, for example. Although the process 950 is described below with respect to the elements of wireless device 202 of FIG. 2, other components may be used to implement one or more of the steps described herein.

At block 952, the method 950 continues from block 608 of the method 600 of FIG. 6. At block 954, the apparatus may send an association request to one of the one or more APs. At block 956, the apparatus may receive an association response from the one of the one or more APs, the association response including an indication for rejection with suggested BSS transition and a list of candidate APs. At block 958, the apparatus may perform BSS transition to associate with one of the candidate APs on the list of the candidate APs. In an aspect, the list of candidate APs is a BSS Transition Candidate List as specified in an IEEE 802.11 specification.

For example, as discussed supra, when a STA sends an association request to an AP, the AP may respond with an association response or a reassociation response that includes the “Rejected with Suggested BSS Transition” indication including BSS transition candidate list entries. Subsequently, for example, as discussed supra, the STA may select an AP among the candidate APs based on the BSS transition candidate list, and may perform BSS transition to associate with the selected AP.

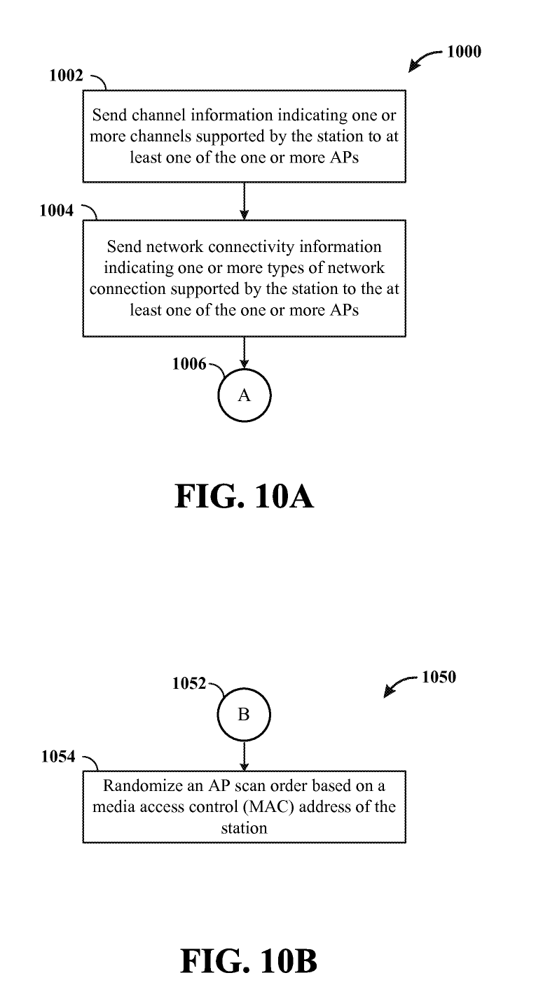

FIG. 10A is a flowchart of an example method 1000 of wireless communication expanding from the aspect illustrated in FIG. 6. The method 1000 may be performed using an apparatus (e.g., the wireless device 202 of FIG. 2, for example). The apparatus may be implemented as a STA 116, for example. Although the process 1400 is described below with respect to the elements of wireless device 202 of FIG. 2, other components may be used to implement one or more of the steps described herein.

At block 1002, the apparatus may send channel information indicating one or more channels supported by the station to at least one of the one or more APs. At block 1004, the apparatus may send network connectivity information indicating one or more types of network connections supported by the station to the at least one of the one or more APs. At block 1006, the method continues to block 601 of FIG. 6. In an aspect, the apparatus receives the AP association information from the at least one of the one or more APs, the AP association information including guidance information that is generated based in part on the channel information to guide the station for association with one of the one or more APs. In an aspect, the guidance information may be generated based further on the network connectivity information. For example, as discussed supra, the STA may send channel information to the AP, where the channel information indicates to the AP what channel(s) or band(s) the apparatus supports. For example, as discussed supra, the AP provides guidance information to the STA, regardless of whether the STA is associated with AP or not. For example, as discussed supra, when the STA receives the guidance information from the AP, the STA may determine to associate with one of the APs based on the guidance information. For example, as discussed supra, the STA may provide network connectivity information indicating one or more types of network connections supported by the STA, and the guidance information may be generated based on the network connectivity information.

In an aspect, the channel information includes preference codes respectively associated with the one or more channels to indicate priorities for the one or more channels, and the channel information further includes a reason code associated with the preference codes. The reason code may indicate one or more reasons for associating the preference codes with the one or more channels. In an aspect, the guidance information includes at least one of load information, security information, IP subnet information, new association indication information with respect to the one or more APs.

FIG. 10B is a flowchart of an example method 1050 of wireless communication expanding from the aspect illustrated in FIG. 6. The method 1050 may be performed using an apparatus (e.g., the wireless device 202 of FIG. 2, for example). The apparatus may be implemented as a STA 116, for example. Although the process 1400 is described below with respect to the elements of wireless device 202 of FIG. 2, other components may be used to implement one or more of the steps described herein

In the example method 1050, the receiving the AP association information at block 602 of FIG. 6 includes receiving a neighbor report from at least one of the one or more APs, where the neighbor report includes at least one of channel information on channels used by the one or more APs, TBTT information for the channels used by the one or more APs, BSS identifiers of the one or more APs, an SSID or a representation of the SSID of the one of the one or more APs, load information of the one or more APs, or FILS indication information of the one or more APs. In an aspect, the apparatus determines to associate with one of the one or more APs based on at least one of the channel information, the TBTT information, the BSS identifiers, the SSID or the representation of the SSID, the load information of the one or more APs, or the FILS indication information included in the neighbor report. For example, as discussed supra, when a STA receives the RNR from an AP, the STA can receive the load information on the AP and other neighbor APs. For example, as discussed supra, when a new STA attempts to locate an AP to associate with, the new STA may obtain the RNR from the AP, and select an AP to associate based on the load information of the surrounding APs in the RNR. For example, as discussed supra, based on the load information on the AP and other neighbor APs, the STA may select an AP to associate, and establish connection with the selected AP. For example, as discussed supra, when a new STA receives the RNR including the FILS indication information, the new STA may use the new association indication information included in the FILS indication information to determine whether to associate with a particular AP.

At block 1052, the method 1050 continues from the block 605 of FIG. 6. At 1054, the apparatus randomizes an AP scan order based on a MAC address of the apparatus. In an aspect, the AP scan order is an order in which the apparatus scans a plurality of channels to determine an AP to associate with the apparatus. In an aspect, the AP scan order prioritizes the channels of the channel information in the neighbor report. For example, as discussed supra, a new STA randomizes the AP scan order (e.g., an order of channels to scan for APs) based on a MAC address associated with the new AP (e.g., via a hash of the MAC address), where the new STA is a STA that is not yet associated with an AP.

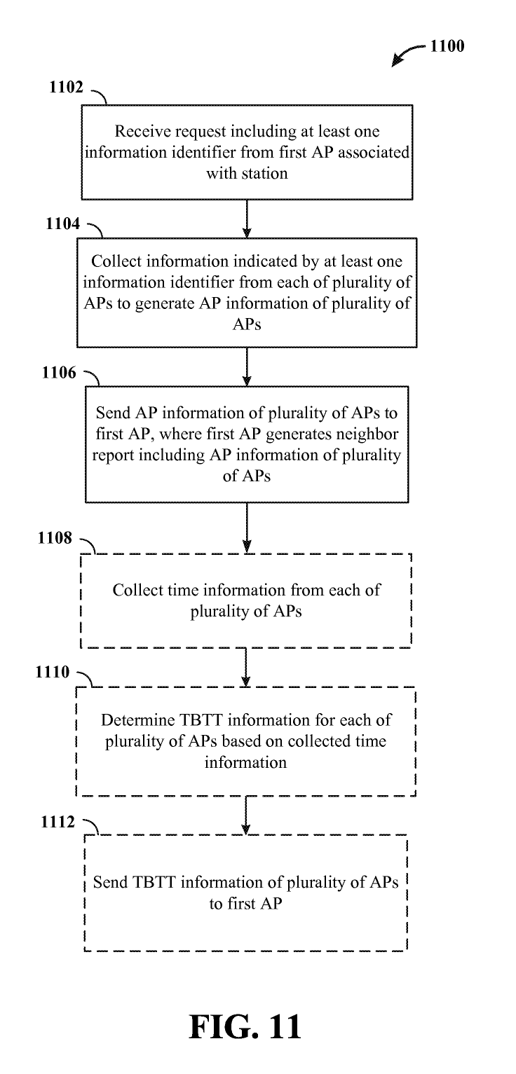

FIG. 11 is a flowchart of an example method 1100 of wireless communication according to an aspect. The method 1100 may be performed using an apparatus (e.g., the wireless device 202 of FIG. 2, for example). The apparatus may be implemented as a STA 116, for example. Although the process 1100 is described below with respect to the elements of wireless device 202 of FIG. 2, other components may be used to implement one or more of the steps described herein.

At block 1102, the apparatus may receive a request including at least one information identifier from a first AP associated with the apparatus. For example, the information identifier may include BSS load IE, a FILS indication IE, etc.

At block 1104, the apparatus may collect information indicated by the at least one information identifier from each of a plurality of APs to generate a report including AP information of the plurality of APs. For example, as discussed supra, when the STA receives a beacon request including the BSS load information identifier from the associated AP, the STA starts gathering load information from each of surrounding APs around the STA to generate a report including the gathered load information of the surrounding APs. AP information may include information about APs such as load information, security information, IP subnet information, new association indication information, etc. For example, if the information identifier is a BSS load IE, the apparatus may gather BSS load information from the surrounding APs, and generate a report including the gathered BSS load information of the surrounding APs. For example, if the information identifier is a FILS indication IE, the apparatus may gather FILS indication information from the surrounding APs, and generate a report including the gathered FILS indication information of the surrounding APs.

At block 1106, the apparatus may send the report including the AP information of the plurality of APs to the first AP to generate a neighbor report including the AP information of the plurality of APs. For example, as discussed supra, an AP associated with a STA may send a beacon request to the STA, where the beacon request may include a BSS load information identifier to indicate that BSS load information should be gathered. Subsequently, for example, as discussed supra, the STA sends the report including the gathered load information of the surrounding APs to the associated AP that sent the beacon request to the STA. For example, as discussed supra, after receiving the report including the gathered load information of the surrounding APs, the associated AP includes the load information of the surrounding APs in the RNR.

In an aspect, the neighbor report is an RNR as specified in an IEEE 802.11 specification. In an aspect, the neighbor report is a Neighbor Report Element as specified in an IEEE 802.11 specification. In an aspect, the neighbor report is used by a second station that is not associated with an AP to select one of the plurality of APs to associate with the second station. In an aspect, the request is a Beacon Request as specified in an IEEE 802.11 specification, and the apparatus sends the report including the AP information of the plurality of APs by sending a Beacon Report as specified in the IEEE 802.11 specification including the AP information of the plurality of APs.

In an aspect, the at least one information identifier received in block 1102 is a load information identifier, and the apparatus collects the information by collecting load information from each of the plurality of APs to generate the report including the AP information that includes the load information of the plurality of APs. In such an aspect, the load information identifier includes BSS Load Information Element as specified in an IEEE 802.11 specification. For example, as discussed supra, the beacon request may include a BSS load information identifier to indicate that BSS load information should be gathered. For example, as discussed supra, if the BSS load information identifier is the BSS load IE in the request element of the Optional Subelements field of the beacon request, the STA receiving the beacon request will gather BSS load information from the surrounding APs.

In an aspect, the at least one information identifier received in block 1102 is a FILS Indication Element as specified in an IEEE 802.11ai specification, and the apparatus collects the information by collecting FILS indication information from each of the plurality of APs to generate FILS indication information of the plurality of APs, where the FILS indication information of the plurality of APs includes at least one of security domain information or IP subnet information of the plurality of APs. In such an aspect, the FILS indication information from each of the plurality of APs includes new association indication information that indicates whether a corresponding AP of the plurality of AP accepts a new association with a station. For example, as discussed supra, when the STA receives a beacon request including the FILS indication information identifier from the associated AP, the STA starts gathering FILS indication information from each of surrounding APs around the STA to generate a report including gathered FILS indication information of the surrounding APs. For example, as discussed supra, the new association indication information may be included as a new field in the FILS indication information of the AP sending the RNR and other neighbor APs.

In an aspect, each of the plurality of APs includes respective new association indication information that indicates whether a corresponding AP of the plurality of AP accepts a new association with the apparatus. In such an aspect, the collecting the information includes collecting the respective new association indication information from each of the plurality of APs to generate the report including the AP information that includes the new association indication information of the plurality of APs. In such an aspect, the at least one information identifier is a new association indication identifier. In such an aspect, the respective new association indication information from each of the plurality of APs is sent to the apparatus via at least one of a beacon probe response, a unicast transmission, or a broadcast transmission. For example, as discussed supra, an AP may include its own new association indication information that indicates whether the AP accepts an additional client, and may be configured to send the new association indication information to the STA. For example, as discussed supra, when the STA receives a beacon request including the new association indication identifier from the associated AP, the STA starts gathering new association indication information from each of surrounding APs around the STA to generate a report including the gathered new association indication information of the surrounding APs. Subsequently, for example, as discussed supra, the STA sends the report including the gathered new association indication information of the surrounding APs to the associated AP that sent the beacon request to the STA. In an aspect, the respective new association indication information from each of the plurality of APs is sent to the apparatus via at least one of FILS Indication information as specified in an IEEE 802.11ai specification or a neighbor report including an RNR as specified in an IEEE 802.11 specification.

In an aspect, the apparatus collecting the information may further collect duration information from each of the plurality of APs, where the duration information indicates a duration during which a corresponding AP of the plurality of AP is not accepting a new association with a station. In such an aspect, the duration information and the new association indication information are sent to the apparatus in the same frame. In an aspect, the apparatus collecting the information may further collect a respective reason code associated with the new association indication information, where the reason code indicates one or more reasons for not accepting a new association with a station. In such an aspect, the reason code and the new association indication information are sent to the apparatus in the same frame. For example, as discussed supra, the AP may further send, to the STA, duration information of the AP, where the duration information indicates a duration during which the AP is not accepting a new association with a station. For example, as discussed supra, the AP may further send, to the STA, a reason code associated with the new association indication information, where the reason code indicates one or more reasons for not accepting a new association with a station. For example, as discussed supra, the duration information and/or the reason code may be sent in the same frame as the frame in which the new association indication is sent.

At block 1108, the apparatus may collect time information from each of the plurality of APs. At block 1110, the apparatus may determine TBTT information for each of the plurality of APs based on the collected time information. At block 1112, the apparatus may send the TBTT information of the plurality of APs to the first AP. In an aspect, the RNR includes the TBTT information of the plurality of APs. In such an aspect, the time information includes beacon interval information and time stamp information from each of the plurality of APs. For example, as discussed supra, the STA may receive a beacon message from each of the surrounding APs, where the beacon message includes time information such as a beacon interval and a timestamp (e.g., current time). For example, as discussed supra, the STA may determine the TBTT information based on the beacon interval and a time stamp, for example, by adding the beacon interval to the time stamp. For example, as discussed supra, the STA subsequently sends the TBTT information of the surrounding APs to the AP associated with the STA, such that the AP associated with the STA may generate the RNR that includes the TBTT information of the surrounding APs.

In an aspect, where the at least one information identifier is a FILS indication identifier, the apparatus collecting the information collects FILS indication information from each of the plurality of APs to generate FILS indication information of the plurality of APs, where the FILS indication information of the plurality of APs includes signal strength thresholds of the plurality of APs, and a second station refrains from associating with one of the plurality of APs if signal strength of at least one of the beacon message or the probe response from the one of the plurality of APs is below a signal strength threshold corresponding to the one of the plurality of AP. For example, as discussed supra, when the STA receives a beacon request including the FILS indication information identifier from the associated AP, the STA starts gathering FILS indication information from each of surrounding APs around the STA to generate a report including the gathered FILS indication information of the surrounding APs. Subsequently, for example, as discussed supra, the STA sends the report including the gathered FILS indication information of the surrounding APs to the associated AP that sent the beacon request to the STA. For example, as discussed supra, after receiving the report including the gathered FILS indication information of the surrounding APs, the associated AP includes the FILS indication information of the surrounding APs in the RNR. For example, as discussed supra, when a new STA receives the RNR including the FILS indication information, the new STA may use the signal strength thresholds of the surrounding APs included in the FILS indication information to determine whether to associate with a particular AP.

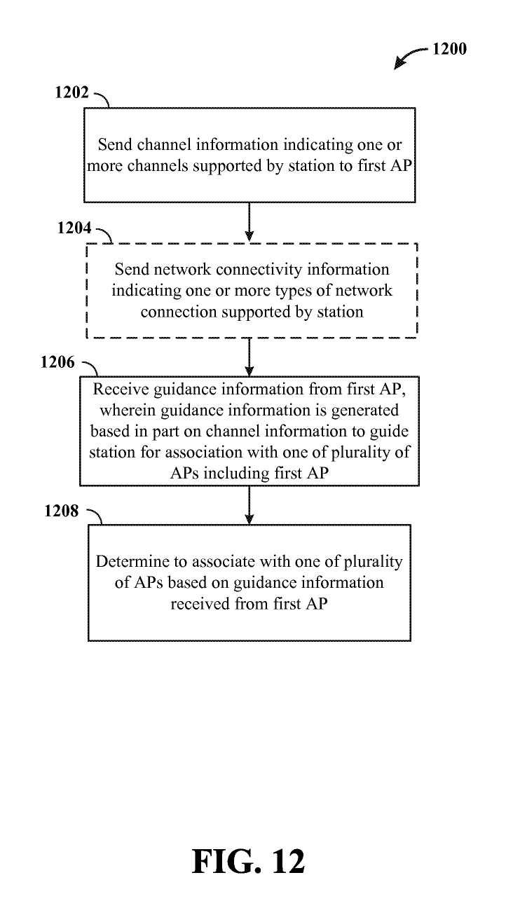

FIG. 12 is a flowchart of an example method 1200 of wireless communication according to an aspect. The method 1200 may be performed using an apparatus (e.g., the wireless device 202 of FIG. 2, for example). The apparatus may be implemented as a STA 116, for example. Although the process 1200 is described below with respect to the elements of wireless device 202 of FIG. 2, other components may be used to implement one or more of the steps described herein.

At block 1202, the apparatus sends channel information indicating one or more channels supported by the apparatus to a first AP. At block 1204, the apparatus sends network connectivity information indicating one or more types of network connections supported by the apparatus. At block 1206, the apparatus receives guidance information from the first AP. In an aspect, the guidance information is generated based further on the network connectivity information. The guidance information is generated based in part on the channel information to guide the apparatus for association with one of a plurality of APs including the first AP.

At block 1208, the apparatus determines to associate with one of the plurality of APs based on the guidance information received from the first AP. For example, as discussed supra, the STA may send channel information to the AP, where the channel information indicates to the AP what channel(s) or band(s) the apparatus supports. For example, as discussed supra, the AP provides guidance information to the STA, regardless of whether the STA is associated with AP or not. For example, as discussed supra, when the STA receives the guidance information from the AP, the STA may determine to associate with one of the APs based on the guidance information. For example, as discussed supra, the STA may provide network connectivity information indicating one or more types of network connections supported by the STA, and the guidance information may be generated based on the network connectivity information.

In an aspect, the channel information sent at block 1202 includes preference codes respectively associated with the one or more channels to indicate priorities for the one or more channels. In an aspect, the channel information further includes a reason code associated with the preference codes, the reason code indicating one or more reasons for associating the preference codes with the one or more channels. In an aspect, the guidance information includes at least one of load information, security information, IP subnet information, new association indication information with respect to the plurality of APs.

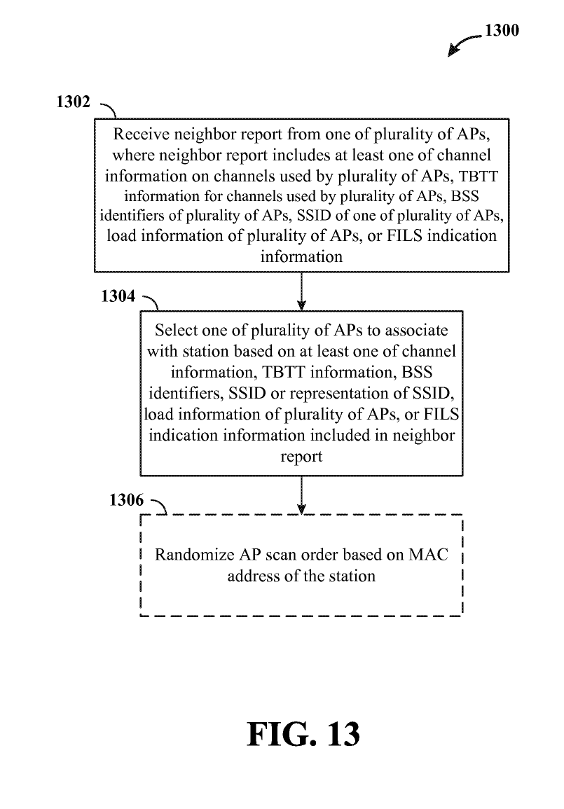

FIG. 13 is a flowchart of an example method 1300 of wireless communication according to another aspect. The method 1300 may be performed using an apparatus (e.g., the wireless device 202 of FIG. 2, for example). The apparatus may be implemented as a STA 116, for example. Although the process 1300 is described below with respect to the elements of wireless device 202 of FIG. 2, other components may be used to implement one or more of the steps described herein.

At block 1302, the apparatus may receive a neighbor report from one of a plurality of APs, where the neighbor report includes at least one of channel information on channels used by the plurality of APs, TBTT information for the channels used by the plurality of APs, BSS identifiers of the plurality of APs, an SSID or a representation of the SSID of the one of the plurality of APs, load information of the plurality of APs, or FILS indication information of the plurality of APs.

At block 1304, the apparatus may select one of the plurality of APs to associate with the apparatus based on at least one of the channel information, the TBTT information, the BSS identifiers, the SSID or the representation of the SSID, the load information of the plurality of APs, or the FILS indication information included in the neighbor report. For example, a new STA that is not yet associated with an AP may receive a neighbor report from a STA. The new STA may select one of surrounding APs to associate based on the information about the APs included in the neighbor report, such as the load information or the FILS indication information of the APs. In an aspect, the neighbor report is an RNR as specified in an IEEE 802.11 specification. In an aspect, the FILS indication information includes at least one of security domain information of the plurality of APs, IP subnet information of the plurality of APs, new association indication information of the plurality of APs, or signal strength thresholds of the plurality of APs, or data thresholds of the plurality of APs. For example, as discussed supra, when a STA receives the RNR from an AP, the STA can receive the load information on the AP and other neighbor APs. For example, as discussed supra, when a new STA attempts to locate an AP to associate with, the new STA may obtain the RNR from the AP, and select an AP to associate based on the load information of the surrounding APs in the RNR. For example, as discussed supra, based on the load information on the AP and other neighbor APs, the STA may select an AP to associate, and establish connection with the selected AP. For example, as discussed supra, when a new STA receives the RNR including the FILS indication information, the new STA may use the new association indication information included in the FILS indication information to determine whether to associate with a particular AP.

At block 1306, the apparatus may randomize an AP scan order based on a MAC address of the apparatus. The AP scan order is an order in which the apparatus scans a plurality of channels to determine an AP with which to associate. In an aspect, the randomizing the AP scan order based on the MAC address of the apparatus is performed based on a hash function applied to the MAC address. For example, as discussed supra, a new STA randomizes the AP scan order (e.g., an order of channels to scan for APs) based on a MAC address associated with the new AP (e.g., via a hash of the MAC address), where the new STA is a STA that is not yet associated with an AP.

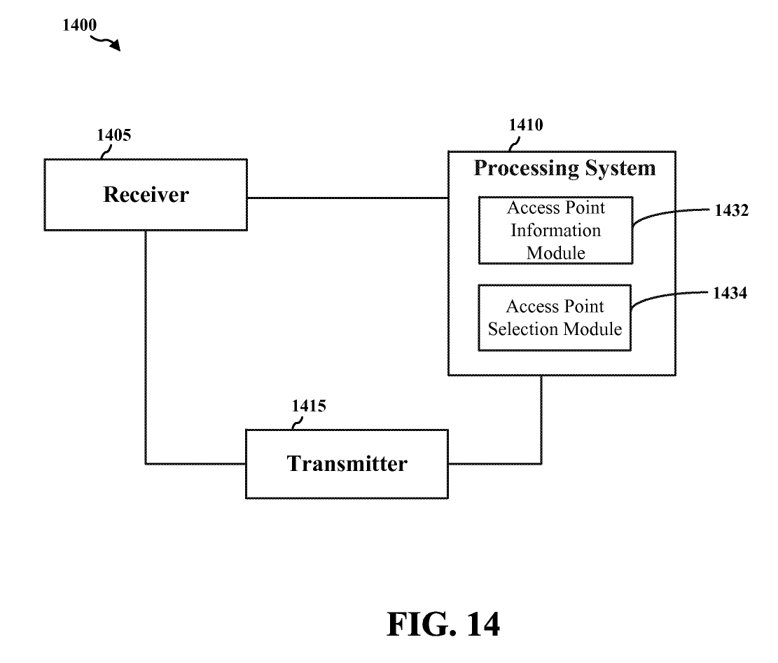

FIG. 14 is a functional block diagram of an example wireless communication device 1400. The wireless communication device 1400 may include a receiver 1405, a processing system 1410, and a transmitter 1415. The processing system 1410 may include an access point information module 1432 and an access point selection module 1434. The access point information module 1432 and the access point selection module 1434 may be circuits. The wireless communication device 1400 may be a station. The receiver 1405 may correspond to the receiver 212. The processing system 1410 may correspond to the processor 204. The transmitter 1415 may correspond to the transmitter 210. The access point information module 1432 may correspond to the access point information module 122 and/or the access point information module 232. The access point selection module 1434 may correspond to the access point selection module 124 and/or the access point selection module 234.

In one configuration, the processing system 1410, the access point information module 1432, and/or the receiver 1405 may be configured to receive AP association information for each of one or more APs. In an aspect, the AP association information for each of the one or more APs may include at least one of new association indication information or load information of a corresponding AP of the one or more APs, where the new association indication information indicates whether the corresponding AP of the one or more APs accepts a new association with a station. In an aspect, the new association indication information includes duration information of a corresponding AP of the one or more APs, the duration information indicating a duration during which the corresponding AP of the one or more of APs is not accepting a new association with a station. In an aspect, the new association indication information includes a respective reason code associated with the new association indication information, where the reason code indicates one or more reasons for not accepting a new association with a station.

In an aspect, the processing system 1410, the access point information module 1432, and/or the receiver 1405 may be configured to receive FILS indication information from each of the one or more APs, where the FILS indication information of a corresponding AP of the one or more APs includes at least one of security domain information or IP subnet information of the corresponding AP of the one or more APs. In an aspect, the determination to associate with one of the one or more APs is further based on the FILS indication information. In an aspect, the FILS indication information from each of the one or more APs includes at least one of new association indication information or load information of a corresponding AP of the one or more APs.

The processing system 1410 and/or the access point selection module 1434 may be configured to determine to associate with one of the one or more APs based on the received AP association information.

In an aspect, the processing system 1410, the access point information module 1432, and/or the receiver 1405 may be configured to receive at least one of a beacon message or a probe response including a signal strength threshold from one of the one or more APs. The processing system 1410 and/or the access point selection module 1434 may be configured to refrain from associating with the one of the one or more APs if signal strength of the at least one of the beacon message or the probe response from the one of the one or more APs is below the signal strength threshold.

In an aspect, the processing system 1410, the access point selection module 1434, and/or the transmitter 1415 may be configured to send an association request to one of the one or more APs. The processing system 1410, the access point selection module 1434, and/or the receiver 1405 may be configured to receive an association reject message from the one of the one or more APs if signal strength of the association request at the one of the one or more APs is below a signal strength threshold. In an aspect, the association reject message includes a suggested BSS transition.

In an aspect, the processing system 1410, the access point selection module 1434, and/or the receiver 1405 may be configured to receive a data communication rate threshold from one of the one or more APs. The processing system 1410, the access point selection module 1434, and/or the transmitter 1415 may be configured to handover to another access point of the one or more APs if a data communication rate of the wireless communication device 1400 is below the data communication rate threshold. In an aspect, the processing system 1410, the access point selection module 1434, and/or the receiver 1405 may be configured to receive a transition request from the one of the one or more APs if the data communication rate of the wireless communication device 1400 is below the data communication rate threshold and no handover of the wireless communication device 1400 has been performed for a predetermined time period. In an aspect, the data communication rate is indicated by an MCS of the wireless communication device 1400, and the data communication rate threshold is a threshold MCS at a specific bandwidth. The processing system 1410, the access point selection module 1434, and/or the transmitter 1415 may be configured to determine to perform a handover from the one of the one or more APs to another AP of the one or more APs in response to receiving the transition request. In an aspect, the transition request is a BSS Transition Request as specified in an IEEE 802.11 specification. Where the transition request includes a disassociation timer, a back-off timer, and a list of candidate APs for a handover, the processing system 1410, the access point selection module 1434, and/or the transmitter 1415 may be configured to disassociate from the one of the one or more APs when the disassociation timer expires. The processing system 1410 and/or the access point selection module 1434 may be configured to refrain from associating with the one of the one or more APs for a time period of the back-off timer after disassociating from the one of the one or more APs.

In an aspect, the processing system 1410, the access point information module 1432, and/or the receiver 1405 may be configured to receive a measurement request from one of the one or more APs that the wireless communication device 1400 is associated with to make measurements on the one or more APs. The processing system 1410, the access point information module 1432, and/or the transmitter 1415 may be configured to send a measurement report including a deferral indication and a deferral time in response to the measurement request, where the deferral indication indicates whether to defer the measurements. In an aspect, the measurements on the one or more APs are deferred for the deferral time if the deferral indication indicates to defer the measurements. The processing system 1410, the access point information module 1432, and/or the receiver 1405 may be configured to receive a second measurement request from the one of the one or more APs that the wireless communication device 1400 is associated with to make measurements on the one or more APs after the deferral time is expired if the deferral indication indicates to defer the measurements.

In an aspect, the processing system 1410, the access point selection module 1434, and/or the transmitter 1415 may be configured to send an association request to one of the one or more APs. The processing system 1410, the access point selection module 1434, and/or the receiver 1405 may be configured to receive an association response from the one of the one or more APs, the association response including an indication for rejection with suggested BSS transition and a list of candidate APs. The processing system 1410, the access point selection module 1434, the transmitter 1415, and/or the receiver 1405 may be configured to perform BSS transition to associate with one of the candidate APs on the list of the candidate APs. In an aspect, the list of candidate APs is a BSS Transition Candidate List as specified in an IEEE 802.11 specification.

In an aspect, the processing system 1410 and/or the transmitter 1415 may be configured to send channel information indicating one or more channels supported by the station to at least one of the one or more APs. The processing system 1410 and/or the transmitter 1415 may be configured to send network connectivity information indicating one or more types of network connections supported by the station to the at least one of the one or more APs. In an aspect, the processing system 1410, the access point information module 1432, and/or the receiver 1405 may receive the AP association information from the at least one of the one or more APs, the AP association information including guidance information that is generated based in part on the channel information to guide the wireless communication device 1400 for association with one of the one or more APs. In an aspect, the guidance information may be generated based further on the network connectivity information. In an aspect, the channel information includes preference codes respectively associated with the one or more channels to indicate priorities for the one or more channels, and the channel information further includes a reason code associated with the preference codes, the reason code indicating one or more reasons for associating the preference codes with the one or more channels. In an aspect, the guidance information includes at least one of load information, security information, IP subnet information, new association indication information with respect to the one or more APs.

In an aspect, the processing system 1410, the access point information module 1432, and/or the receiver 1405 may be configured to receive the AP association information by receiving a neighbor report from at least one of the one or more APs, where the neighbor report includes at least one of channel information on channels used by the one or more APs, TBTT information for the channels used by the plurality of APs, BSS identifiers of the one or more APs, an SSID or a representation of the SSID of the one of the one or more APs, load information of the one or more APs, or FILS indication information of the one or more APs. In an aspect, the processing system 1410, the access point selection module 1434, and/or the transmitter 1415 may determine to associate with one of the one or more APs based on at least one of the channel information, the TBTT information, the BSS identifiers, the SSID or the representation of the SSID, the load information of the one or more APs, or the FILS indication information included in the neighbor report. The processing system 1410 and/or the access point selection module 1434 may be configured to randomize an AP scan order based on a MAC address of the wireless communication device 1400. In an aspect, the AP scan order is an order in which the wireless communication device 1400 scans a plurality of channels to determine an AP to associate with the wireless communication device 1400. In an aspect, the AP scan order prioritizes the channels of the channel information in the neighbor report.

In this configuration, the receiver 1405, the processing system 1410, the access point information module 1432, access point selection module 1434, and/or the transmitter 1415 may be configured to perform one or more functions discussed above with respect to blocks 601, 602, 604, 605, 606, and 608 of FIG. 6, blocks 702, 704, and 706 of FIG. 7A, blocks 752, 754, and 756 of FIG. 7B, blocks 802, 804, 806, 808, 810, 812, and 813 of FIG. 8, blocks 902, 904, 906, and 908 of FIG. 9A, blocks 952, 954, 956, and 958 of FIG. 9B, blocks 1002, 1004, and 1006 of FIG. 10A, and blocks 1052 and 1054 of FIG. 10B.

In another configuration, the processing system 1410, the access point information module 1432, and/or the receiver 1405 may be configured to receive a request including at least one information identifier from a first AP associated with the wireless communication device 1400. For example, the information identifier may include BSS load IE, a FILS indication IE, etc. The processing system 1410, the access point information module 1432, and/or the receiver 1405 may be configured to collect information indicated by the at least one information identifier from each of a plurality of APs to generate a report including AP information of the plurality of APs.

The processing system 1410, the access point information module 1432, and/or the transmitter 1415 may be configured to send the report including the AP information of the plurality of APs to the first AP, where the first AP generates a neighbor report including the AP information of the plurality of APs. In an aspect, the neighbor report is an RNR as specified in an IEEE 802.11 specification. In an aspect, the neighbor report is a Neighbor Report Element as specified in an IEEE 802.11 specification. In an aspect, the neighbor report is used by a second station that is not associated with an AP to select one of the plurality of APs to associate with the second station. In an aspect, the request is a Beacon Request as specified in an IEEE 802.11 specification, and the processing system 1410, the access point information module 1432, and/or the transmitter 1415 may be configured to send the report including the AP information of the plurality of APs by sending a Beacon Report as specified in the IEEE 802.11 specification including the AP information of the plurality of APs. In an aspect, the at least one information identifier is a load information identifier, and the processing system 1410, the access point information module 1432, and/or the receiver 1405 may be configured to collect the information by collecting load information from each of the plurality of APs to generate the report including the AP information that includes the load information of the plurality of APs. In such an aspect, the load information identifier includes BSS Load Information Element as specified in an IEEE 802.11 specification.

In an aspect, the at least one information identifier is a FILS Indication Element as specified in an IEEE 802.11ai specification, and the processing system 1410, the access point information module 1432, and/or the receiver 1405 may be configured to collect the information by collecting FILS indication information from each of the plurality of APs to generate FILS indication information of the plurality of APs, where the FILS indication information of the plurality of APs includes at least one of security domain information or IP subnet information of the plurality of APs. In such an aspect, the FILS indication information from each of the plurality of APs includes new association indication information that indicates whether a corresponding AP of the plurality of AP accepts a new association with a station.

In an aspect, each of the plurality of APs includes respective new association indication information that indicates whether a corresponding AP of the plurality of AP accepts a new association with the wireless communication device 1400. In such an aspect, the collecting the information includes collecting the respective new association indication information from each of the plurality of APs to generate the report including the AP information that includes the new association indication information of the plurality of APs. In such an aspect, the at least one information identifier is a new association indication identifier. In such an aspect, the respective new association indication information from each of the plurality of APs is sent to the wireless communication device 1400 via at least one of a beacon probe response, a unicast transmission, or a broadcast transmission.

In an aspect, the processing system 1410, the access point information module 1432, and/or the receiver 1405 may be configured to collect the information by collecting duration information from each of the plurality of APs, where the duration information indicates a duration during which a corresponding AP of the plurality of AP is not accepting a new association with a station. In such an aspect, the duration information and the new association indication information are sent to the wireless communication device 1400 in the same frame. In an aspect, the access point information module 1432, and/or the receiver 1405 may be configured to collect the information by collecting a respective reason code associated with the new association indication information, where the reason code indicates one or more reasons for not accepting a new association with a station. In such an aspect, the reason code and the new association indication information are sent to the wireless communication device 1400 in the same frame.

In an aspect, the processing system 1410, the access point information module 1432 and/or the receiver 1405 may be configured to collect time information from each of the plurality of APs. The processing system 1410 and/or the access point information module 1432 may be configured to may determine TBTT information for each of the plurality of APs based on the collected time information. The processing system 1410, the access point information module 1432, and/or the transmitter 1415 may be configured to send the TBTT information of the plurality of APs to the first AP. In an aspect, the RNR includes the TBTT information of the plurality of APs. In such an aspect, the time information includes beacon interval information and time stamp information from each of the plurality of APs. In an aspect, where the at least one information identifier is a FILS indication identifier, the access point information module 1432, and/or the receiver 1405 may be configured to collect the information by collecting FILS indication information from each of the plurality of APs to generate FILS indication information of the plurality of APs, where the FILS indication information of the plurality of APs includes signal strength thresholds of the plurality of APs, and a second station refrains from associating with one of the plurality of APs if signal strength of at least one of the beacon message or the probe response from the one of the plurality of APs is below a signal strength threshold corresponding to the one of the plurality of AP.

In this configuration, the receiver 1405, the processing system 1410, the access point information module 1432, and/or the transmitter 1415 may be configured to perform one or more functions discussed above with respect to blocks 1102, 1104, 1106, 1108, 1110, 1112 of FIG. 11.

In another configuration, the processing system 1410 and/or the transmitter 1415 may be configured to send channel information indicating one or more channels supported by the wireless communication device 1400 to a first AP. The processing system 1410 and/or the transmitter 1415 may be configured to send network connectivity information indicating one or more types of network connections supported by the wireless communication device 1400. In an aspect, the guidance information is generated based further on the network connectivity information. The processing system 1410, the access point selection module 1434, and/or the receiver 1405 may be configured to receive guidance information from the first AP, where the guidance information is generated based in part on the channel information to guide the wireless communication device 1400 for association with one of a plurality of APs including the first AP. The processing system 1410 and/or the access point selection module 1434 may be configured to determine to associate with one of the plurality of APs based on the guidance information received from the first AP. In an aspect, the channel information includes preference codes respectively associated with the one or more channels to indicate priorities for the one or more channels. In an aspect, the channel information further includes a reason code associated with the preference codes, the reason code indicating one or more reasons for associating the preference codes with the one or more channels. In an aspect, the guidance information includes at least one of load information, security information, IP subnet information, new association indication information with respect to the plurality of APs.

In this configuration, the receiver 1405, the processing system 1410, access point selection module 1434, and/or the transmitter 1415 may be configured to perform one or more functions discussed above with respect to blocks 1202, 1204, 1206, and 1208 of FIG. 12.

In another configuration, the processing system 1410, the access point information module 1432, and/or the receiver 1405 may be configured to receive a neighbor report from one of a plurality of APs, where the neighbor report includes at least one of channel information on channels used by the plurality of APs, TBTT information for the channels used by the plurality of APs, BSS identifiers of the plurality of APs, an SSID or a representation of the SSID of the one of the plurality of APs, load information of the plurality of APs, or FILS indication information of the plurality of APs. The processing system 1410 and/or the access point selection module 1434 may be configured to select one of the plurality of APs to associate with the wireless communication device 1400 based on at least one of the channel information, the TBTT information, the BSS identifiers, the SSID or the representation of the SSID, the load information of the plurality of APs, or the FILS indication information included in the neighbor report. In an aspect, the neighbor report is an RNR as specified in an IEEE 802.11 specification. In an aspect, the FILS indication information includes at least one of security domain information of the plurality of APs, IP subnet information of the plurality of APs, new association indication information of the plurality of APs, or signal strength thresholds of the plurality of APs, or data thresholds of the plurality of APs. The processing system 1410 and/or the access point selection module 1434 may be configured to randomize an AP scan order based on a MAC address of the wireless communication device 1400, where the AP scan order is an order in which the wireless communication device 1400 scans a plurality of channels to determine an AP to associate with the wireless communication device 1400. In an aspect, the randomizing the AP scan order based on the MAC address of the wireless communication device 1400 is performed based on a hash function applied to the MAC address.

In this configuration, the receiver 1405, the processing system 1410, the access point information module 1432, access point selection module 1434, and/or the transmitter 1415 may be configured to perform one or more functions discussed above with respect to blocks 1302, 1304, and 1306 of FIG. 13.

Moreover, means for receiving AP association information for each of one or more APs may include the processing system 1410, the access point information module 1432, and/or the receiver 1405. Means for determining to associate with one of the one or more APs based on the received AP association information may include the processing system 1410 and/or the access point selection module 1434. Means for receiving FILS indication information from each of the one or more APs may include the processing system 1410, the access point information module 1432, and/or the receiver 1405. Means for receiving at least one of a beacon message or a probe response including a signal strength threshold from one of the one or more APs may include the processing system 1410, the access point information module 1432, and/or the receiver 1405. Means for refraining from associating with the one of the one or more APs if signal strength of the at least one of the beacon message or the probe response from the one of the one or more APs is below the signal strength threshold may include the processing system 1410 and/or the access point selection module 1434.

Means for sending an association request to one of the one or more APs may include the processing system 1410, the access point selection module 1434, and/or the transmitter 1415. Means for receiving an association reject message from the one of the one or more APs if signal strength of the association request at the one of the one or more APs is below a signal strength threshold may include the processing system 1410, the access point selection module 1434, and/or the receiver 1405. Means for receiving a data communication rate threshold from one of the one or more APs may include the processing system 1410, the access point information module 1432, and/or the receiver 1405. Means for determining to handover to another AP of the one or more APs if a data communication rate of the station is below the data communication rate threshold may include the processing system 1410, the access point selection module 1434, and/or the transmitter 1415.

Means for receiving a transition request from the one of the one or more APs if the data communication rate of the station is below the data communication rate threshold and no handover of the station has been performed for a predetermined time period may include the processing system 1410, the access point selection module 1434, and/or the receiver 1405. Means for determining to perform a handover from the one of the one or more APs to another AP of the one or more APs in response to receiving the transition request may include the processing system 1410, the access point selection module 1434, and/or the transmitter 1415. Means for refraining from associating with the one of the one or more APs for a time period of the back-off timer after disassociating from the one of the one or more APs may include the processing system 1410 and/or the access point selection module 1434.

Means for receiving a measurement request from one of the one or more APs that the station is associated with to make measurements on the one or more APs may include the processing system 1410, the access point information module 1432, and/or the receiver 1405. Means for sending a measurement report including a deferral indication and a deferral time in response to the measurement request may include the processing system 1410, the access point information module 1432, and/or the transmitter 1415. Means for receiving a second measurement request from the one of the one or more APs that the station is associated with to make measurements on the one or more APs after the deferral time is expired if the deferral indication indicates to defer the measurements may include the processing system 1410, the access point information module 1432, and/or the receiver 1405. Means for sending an association request to one of the one or more APs may include the processing system 1410, the access point selection module 1434, and/or the transmitter 1415. Means for receiving an association response from the one of the one or more APs, the association response including an indication for rejection with suggested BSS transition and a list of candidate APs may include the processing system 1410, the access point selection module 1434, and/or the receiver 1405. Means for performing BSS transition to associate with one of the candidate APs on the list of the candidate APs may include the processing system 1410, the access point selection module 1434, and/or the transmitter 1415.

Means for sending channel information indicating one or more channels supported by the station to at least one of the one or more APs may include the processing system 1410 and/or the transmitter 1415. Means for sending network connectivity information indicating one or more types of network connections supported by the station to the at least one of the one or more APs may include the processing system 1410 and/or the transmitter 1415.

Means for receiving a neighbor report from at least one of the one or more APs may include the processing system 1410, the access point information module 1432, and/or the receiver 1405. Means for randomizing an AP scan order based on a MAC address of the station may include the processing system 1410 and/or the access point information module 1432.

Means for receiving a request including at least one information identifier from a first AP associated with the station may include the processing system 1410, the access point information module 1432, and/or the receiver 1405. Means for collecting information indicated by the at least one information identifier from each of a plurality of APs to generate a report including AP information of the plurality of APs may include the processing system 1410, the access point information module 1432, and/or the receiver 1405. Means for sending the report including the AP information of the plurality of APs to the first AP to generate a neighbor report including the AP information of the plurality of APs may include the processing system 1410, the access point information module 1432, and/or the transmitter 1415. Means for collecting time information from each of the plurality of APs may include the processing system 1410, the access point information module 1432, and/or the receiver 1405. Means for determining TBTT information for each of the plurality of APs based on the collected time information may include the processing system 1410 and/or the access point information module 1432. Means for sending the TBTT information of the plurality of APs to the first AP may include the processing system 1410, the access point information module 1432, and/or the transmitter 1415.

Means for sending channel information indicating one or more channels supported by the station to a first AP may include the processing system 1410 and/or the receiver 1405. Means for receiving guidance information from the first AP may include the processing system 1410, the access point selection module 1434, and/or the receiver 1405. Means for determining to associate with one of the plurality of APs based on the guidance information received from the first AP may include the processing system 1410 and/or the access point selection module 1434. Means for sending network connectivity information indicating one or more types of network connections supported by the station may include the processing system 1410 and/or the transmitter 1415.

Means for receiving a neighbor report from one of a plurality of access points (APs) may include the processing system 1410, the access point information module 1432, and/or the receiver 1405. Means for selecting one of the plurality of APs to associate with the station based on at least one of the load information of the plurality of APs or the FILS indication information included in the neighbor report may include the processing system 1410 and/or the access point selection module 1434. Means for randomizing an AP scan order based on a MAC address of the station may include the processing system 1410 and/or the access point selection module 1434.

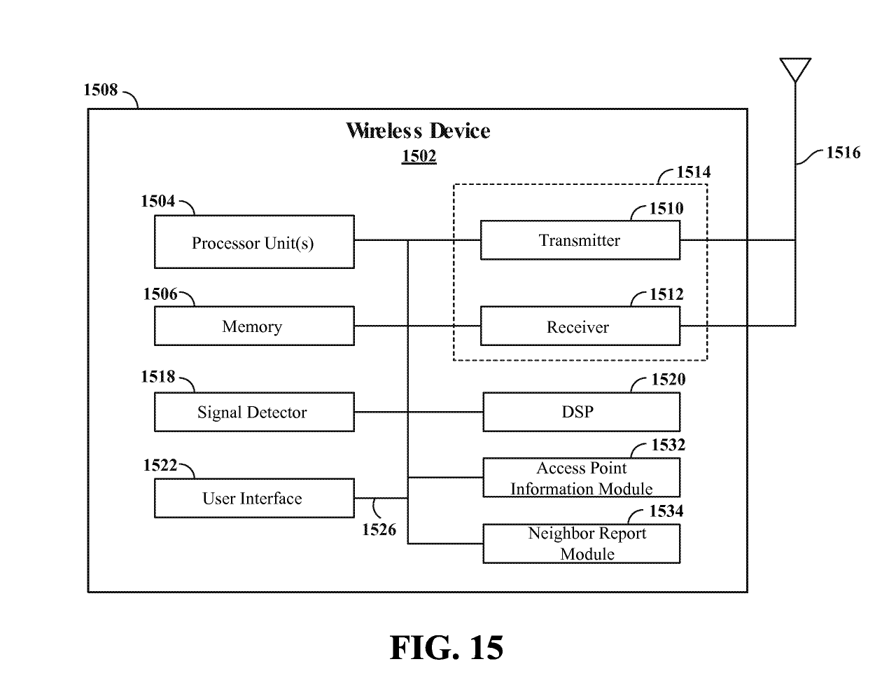

FIG. 15 shows an example functional block diagram of a wireless device 1502 that may be employed within the wireless communication system 100 of FIG. 1. The wireless device 1502 is an example of a device that may be configured to implement the various methods described herein. For example, the wireless device 1502 may comprise the AP 104.

The wireless device 1502 may include a processor 1504 which controls operation of the wireless device 1502. The processor 1504 may also be referred to as a CPU. Memory 1506, which may include both ROM and RAM, may provide instructions and data to the processor 1504. A portion of the memory 1506 may also include NVRAM. The processor 1504 typically performs logical and arithmetic operations based on program instructions stored within the memory 1506. The instructions in the memory 1506 may be executable to implement the methods described herein.

The processor 1504 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1502 may also include a housing 1508 that may include a transmitter 1510 and/or a receiver 1512 to allow transmission and reception of data between the wireless device 1502 and a remote location. The transmitter 1510 and receiver 1512 may be combined into a transceiver 1514. An antenna 1516 may be attached to the housing 1508 and electrically coupled to the transceiver 1514. The wireless device 1502 may also include (not shown) multiple transmitters, multiple receivers, multiple transceivers, and/or multiple antennas.

The wireless device 1502 may also include a signal detector 1518 that may be used in an effort to detect and quantify the level of signals received by the transceiver 1514. The signal detector 1518 may detect such signals as total energy, energy per subcarrier per symbol, power spectral density and other signals. The wireless device 1502 may also include a DSP 1520 for use in processing signals. The DSP 1520 may be configured to generate a packet for transmission. In some aspects, the packet may comprise a PPDU.

The wireless device 1502 may further comprise a user interface 1522 in some aspects. The user interface 1522 may comprise a keypad, a microphone, a speaker, and/or a display. The user interface 1522 may include any element or component that conveys information to a user of the wireless device 1502 and/or receives input from the user.

The wireless device 1502 may comprise an access point information module 1532. The wireless device 1502 may further comprise a neighbor report module 1534. The access point information module 1532 may be configured to send a request including at least one information identifier to a station associated with the AP, and to receive the AP information of the plurality of APs from the station. The neighbor report module 1534 may be configured to generate a neighbor report including the AP information of the plurality of APs.

The various components of the wireless device 1502 may be coupled together by a bus system 1526. The bus system 1526 may include a data bus, for example, as well as a power bus, a control signal bus, and a status signal bus in addition to the data bus. Components of the wireless device 1502 may be coupled together or accept or provide inputs to each other using some other mechanism.

Although a number of separate components are illustrated in FIG. 15, one or more of the components may be combined or commonly implemented. For example, the processor 1504 may be used to implement not only the functionality described above with respect to the processor 1504, but also to implement the functionality described above with respect to the signal detector 1518 and/or the DSP 1520. Further, each of the components illustrated in FIG. 15 may be implemented using a plurality of separate elements.

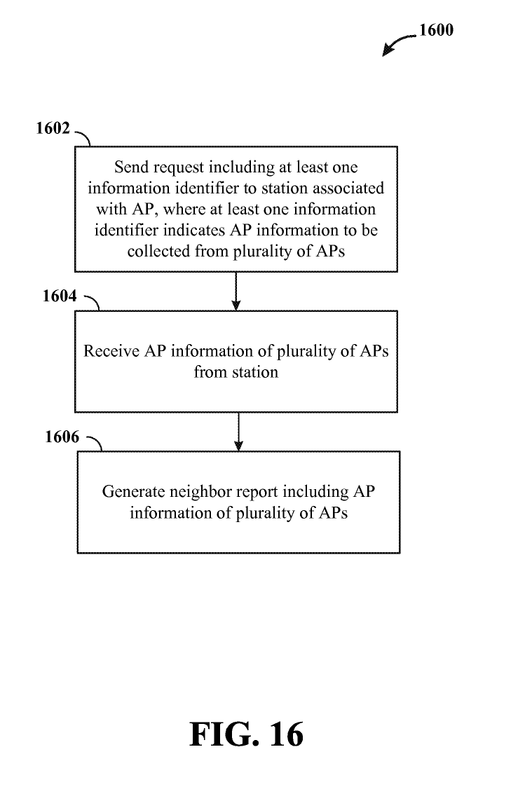

FIG. 16 is a flowchart of an example method 1600 of wireless communication according to another aspect. The method 1600 may be performed using an apparatus (e.g., the wireless device 1502 of FIG. 15, for example). The apparatus may be implemented as an AP 104, for example. Although the process 1600 is described below with respect to the elements of wireless device 1502 of FIG. 15, other components may be used to implement one or more of the steps described herein.

At block 1602, the apparatus may send a request including at least one information identifier to a station associated with the AP, where the at least one information identifier indicates AP information to be collected from a plurality of APs. At block 1604, the apparatus may receive the AP information of the plurality of APs from the station. At block 1606, the apparatus may generate a neighbor report including the AP information of the plurality of APs. For example, an AP may send a request including a BSS IE and/or a FILS indication IE to a STA associated with the AP, such that the STA may gather the BSS load information and/or the FILS indication information from the surrounding APs. Subsequently, the AP may receive the gathered BSS load information and/or the FILS indication information of the surrounding APs, and include such AP information in a neighbor report.

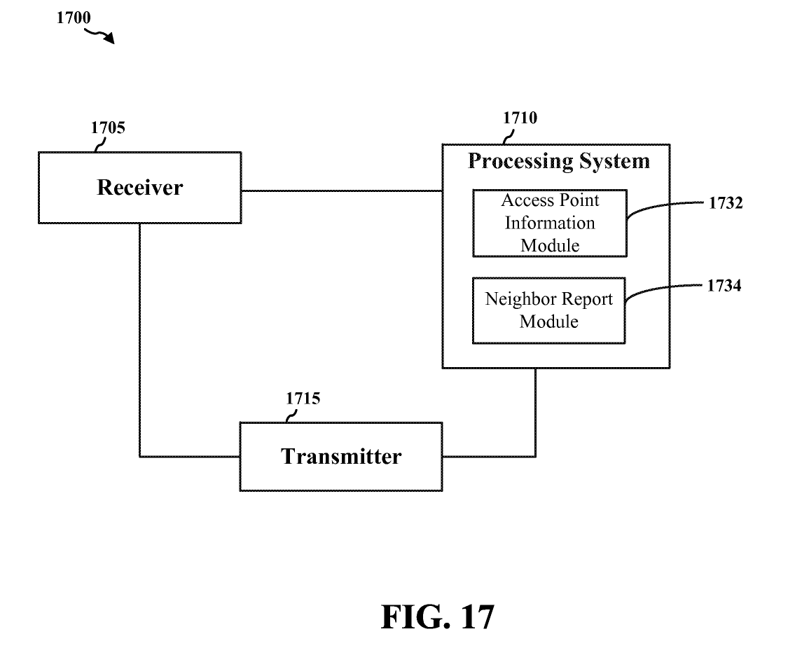

FIG. 17 is a functional block diagram of an example wireless communication device 1700. The wireless communication device 1700 may include a receiver 1705, a processing system 1710, and a transmitter 1715. The processing system 1710 may include an access point information module 1732 and a neighbor report module 1734. The access point information module 1732 and the neighbor report module 1734 may be circuits. The wireless communication device 1700 may be an AP. The receiver 1705 may correspond to the receiver 1512. The processing system 1710 may correspond to the processor 1504. The transmitter 1715 may correspond to the transmitter 1510. The access point information module 1732 may correspond to the access point information module 132 and/or the access point information module 1532. The neighbor report module 1734 may correspond to the neighbor report module 134 and/or the neighbor report module 1534.

In one configuration, the processing system 1710, the access point information module 1732, and/or the transmitter 1715 may be configured to send a request including at least one information identifier to a station associated with the AP. The processing system 1710, the access point information module 1732, and/or the receiver 1705 may be configured to receive the AP information of the plurality of APs from the station. The processing system 1710 and/or the neighbor report module 1734 may be configured to generate a neighbor report including the AP information of the plurality of APs.

In this configuration, the receiver 1705, the processing system 1710, the access point information module 1732, the neighbor report module 1734, and/or the transmitter 1715 may be configured to perform one or more functions discussed above with respect to blocks 1602, 1604, and 1606 of FIG. 16.

Moreover, means for sending a request including at least one information identifier to a station associated with the AP may include the processing system 1710, the access point information module 1732, and/or the transmitter 1715. Means for receiving the AP information of the plurality of APs from the station may include the processing system 1710, the access point information module 1732, and/or the receiver 1705. Means for generating a neighbor report including the AP information of the plurality of APs may include the processing system 1710 and/or the neighbor report module 1734.

As used herein, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication by a station, comprising:
receiving access point (AP) association information for each of one or more APs; and
determining to associate with one of the one or more APs based on the received AP association information.

2. The method of claim 1, wherein the AP association information for each of the one or more APs includes at least one of:
new association indication information, the new association indication information indicating whether the corresponding AP of the one or more APs accepts a new association with a station; or
load information of a corresponding AP of the one or more APs.

3. The method of claim 2, wherein the new association indication information comprises at least one of:
duration information of a corresponding AP of the one or more APs, the duration information indicating a duration during which the corresponding AP of the one or more of APs is not accepting a new association with a station; or
a respective reason code associated with the new association indication information, the reason code indicating one or more reasons for not accepting a new association with a station.

4. The method of claim 1, further comprising:
receiving fast initial link setup (FILS) indication information from each of the one or more APs, wherein the FILS indication information of a corresponding AP of the one or more APs includes at least one of security domain information or IP subnet information of the corresponding AP of the one or more APs,
wherein the determination to associate with one of the one or more APs is further based on the FILS indication information.

5. The method of claim 4, wherein the FILS indication information from each of the one or more APs includes at least one of new association indication information or load information of a corresponding AP of the one or more APs, the new association indication information indicating whether the corresponding AP of the one or more APs accepts a new association with a station.

6. The method of claim 1, further comprising:
receiving at least one of a beacon message or a probe response including a signal strength threshold from one of the one or more APs; and
refraining from associating with the one of the one or more APs if signal strength of the at least one of the beacon message or the probe response from the one of the one or more APs is below the signal strength threshold.

7. The method of claim 1, further comprising:
sending an association request to one of the one or more APs; and
receiving an association reject message from the one of the one or more APs if signal strength of the association request at the one of the one or more APs is below a signal strength threshold.

8. The method of claim 1, further comprising:
receiving a data communication rate threshold from one of the one or more APs; and
determining to handover to another AP of the one or more APs if a data communication rate of the station is below the data communication rate threshold.

9. The method of claim 8, further comprising:
receiving a transition request from the one of the one or more APs if the data communication rate of the station is below the data communication rate threshold and no handover of the station has been performed for a predetermined time period; and
determining to perform a handover from the one of the one or more APs to another AP of the one or more APs in response to receiving the transition request.

10. The method of claim 9, wherein the transition request includes a disassociation timer, a back-off timer, and a list of candidate APs for a handover, and wherein the method further comprises disassociating from the one of the one or more APs when the disassociation timer expires.

11. The method of claim 10, further comprising:
refraining from associating with the one of the one or more APs for a time period of the back-off timer after disassociating from the one of the one or more APs.

12. The method of claim 1, further comprising:
receiving a measurement request from one of the one or more APs that the station is associated with to make measurements on the one or more APs; and
sending a measurement report including a deferral indication and a deferral time in response to the measurement request, wherein the deferral indication indicates whether to defer the measurements,
wherein the measurements on the one or more APs are deferred for the deferral time if the deferral indication indicates to defer the measurements.

13. The method of claim 12, further comprising:
receiving a second measurement request from the one of the one or more APs that the station is associated with to make measurements on the one or more APs after the deferral time is expired if the deferral indication indicates to defer the measurements.

14. The method of claim 1, further comprising:
sending an association request to one of the one or more APs;
receiving an association response from the one of the one or more APs, the association response including an indication for rejection with suggested basic service set (BSS) transition and a list of candidate APs; and
performing BSS transition to associate with one of the candidate APs on the list of the candidate APs.

15. The method of claim 1, further comprising:
sending channel information indicating one or more channels supported by the station to at least one of the one or more APs,
wherein the station receives the AP association information from the at least one of the one or more APs, the AP association information including guidance information that is generated based in part on the channel information to guide the station for association with one of the one or more APs.

16. The method of claim 15, wherein the channel information includes preference codes respectively associated with the one or more channels to indicate priorities for the one or more channels, and
wherein the channel information further includes a reason code associated with the preference codes, the reason code indicating one or more reasons for associating the preference codes with the one or more channels.

17. The method of claim 15, wherein the guidance information includes at least one of load information, security information, IP subnet information, new association indication information with respect to the one or more APs.

18. The method of claim 15, further comprising:
sending network connectivity information indicating one or more types of network connections supported by the station to the at least one of the one or more APs,
wherein the guidance information is generated based further on the network connectivity information.

19. The method of claim 1, wherein the receiving the AP association information includes:
receiving a neighbor report from at least one of the one or more APs, wherein the neighbor report includes at least one of channel information on channels used by the one or more APs, target beacon transmission time (TBTT) information for the channels used by the one or more APs, basic service set (BSS) identifiers of the one or more APs, a service set identifier (SSID) or a representation of the SSID of the one of the one or more APs, load information of the one or more APs, or FILS indication information of the one or more APs,
wherein the station determines to associate with one of the one or more APs based on at least one of the channel information, the TBTT information, the BSS identifiers, the SSID or the representation of the SSID, the load information of the one or more APs, or the FILS indication information included in the neighbor report.

20. The method of claim 19, further comprising:
randomizing an AP scan order based on a media access control (MAC) address of the station,
wherein the AP scan order is an order in which the station scans a plurality of channels to determine an AP to associate with the station, and
wherein the AP scan order prioritizes the channels of the channel information in the neighbor report.

21. A method of wireless communication by a station, comprising:
receiving a request including at least one information identifier from a first access point (AP) associated with the station;
collecting information indicated by the at least one information identifier from each of a plurality of APs to generate a report including AP information of the plurality of APs; and
sending the report including the AP information of the plurality of APs to the first AP to generate a neighbor report including the AP information of the plurality of APs.

22. The method of claim 21, wherein the neighbor report is used by a second station that is not associated with an AP to select one of the plurality of APs to associate with the second station.

23. The method of claim 21, wherein:
if the at least one information identifier is a load information identifier, the collecting the information comprises collecting load information from each of the plurality of APs to generate the report including the AP information that includes the load information of the plurality of APs, and
if the at least one information identifier is a fast initial link setup (FILS) Indication Element as specified in an IEEE 802.11ai specification, the collecting the information comprises collecting FILS indication information from each of the plurality of APs to generate FILS indication information of the plurality of APs, wherein the FILS indication information of the plurality of APs includes at least one of security domain information or IP subnet information of the plurality of APs.

24. The method of claim 23, wherein the FILS indication information from each of the plurality of APs includes new association indication information that indicates whether a corresponding AP of the plurality of AP accepts a new association with a station.

25. The method of claim 21, wherein each of the plurality of APs includes respective new association indication information that indicates whether a corresponding AP of the plurality of AP accepts a new association with the station, and
wherein the collecting the information comprises collecting the respective new association indication information from each of the plurality of APs to generate the report including the AP information that includes the new association indication information of the plurality of APs.

26. The method of claim 25, wherein the collecting the information further comprises at least one of collecting duration information from each of the plurality of APs or collecting a respective reason code associated with the new association indication information, wherein the duration information indicates a duration during which a corresponding AP of the plurality of AP is not accepting a new association with a station, and wherein the reason code indicates one or more reasons for not accepting a new association with a station.

27. The method of claim 21, further comprising:
collecting time information from each of the plurality of APs;
determining target beacon transmission time (TBTT) information for each of the plurality of APs based on the collected time information; and
sending the TBTT information of the plurality of APs to the first AP,
wherein the neighbor report includes the TBTT information of the plurality of APs.

28. The method of claim 21, wherein:
the at least one information identifier is a fast initial link setup (FILS) indication identifier,
the collecting the information comprises collecting FILS indication information from each of the plurality of APs to generate FILS indication information of the plurality of APs, wherein the FILS indication information of the plurality of APs includes signal strength thresholds of the plurality of APs, and
a second station refrains from associating with one of the plurality of APs if signal strength of at least one of a beacon message or a probe response from the one of the plurality of APs is below a signal strength threshold corresponding to the one of the plurality of AP.

29. A station for wireless communication, comprising:
a memory; and
at least one processor coupled to the memory and configured to:
receive access point (AP) association information for each of one or more APs; and
determine to associate with one of the one or more APs based on the received AP association information.

30. A station for wireless communication, comprising:
a memory; and
at least one processor coupled to the memory and configured to:
receive a request including at least one information identifier from a first access point (AP) associated with the station;
collect information indicated by the at least one information identifier from each of a plurality of APs to generate a report including AP information of the plurality of APs; and
send the report including the AP information of the plurality of APs to the first AP to generate a neighbor report including the AP information of the plurality of APs.
